(19) United States
(12) Patent Application Publication
(10) Pub. No.: US 2019/0014596 A1
(43) Pub. Date: Jan. 10, 2019

(54) METHOD AND DEVICE FOR CONFIGURING COMPETITION ACCESS PARAMETERS OF LICENSED-ASSISTED ACCESS EQUIPMENT

(71) Applicant: ZTE Corporation, Shenzhen (CN)

(72) Inventors: Ling YANG, Shenzhen (CN); Wei GOU, Shenzhen (CN); Focai PENG, Shenzhen (CN); Feng BI, Shenzhen (CN); Xincai LI, Shenzhen (CN); Yajun ZHAO, Shenzhen (CN)

(21) Appl. No.: 15/763,319

(22) PCT Filed: Sep. 23, 2016
(86) PCT No.: PCT/CN2016/099933

§ 371 Date: Sep. 18, 2018

(30) Foreign Application Priority Data
Sep. 25, 2015 (CN) 201510624671.X

(51) Int. Cl. H04W 74/08; H04W 72/14; H04W 72/12; H04W 72/04; H04W 72/08

(52) U.S. Cl. CPC H04W 74/08; H04W 72/14; H04W 72/085; H04W 72/0446; H04W 72/1284

(57) ABSTRACT

Provided are a method and apparatus for configuring contention-based access parameters of a Licensed-Assisted Access (LAA) device. The method includes: determining, according to different priority classes, different Listen Before Talk (LBT) mechanisms or different LBT mechanism parameter sets corresponding to the different priority classes; executing contention-based access to an unlicensed carrier by using the different LBT mechanisms or the different LBT mechanism parameter sets corresponding to the different priority classes; and when a right of using the unlicensed carrier is successfully gained based on a used LBT mechanism or a used LBT mechanism parameter set, transmitting data by utilizing the unlicensed carrier.

### TECHNICAL FIELD

The disclosure relates to an LAA technology in wireless communications, and more particularly to a method and apparatus for configuring contention-based access parameters of an LAA device.

### BACKGROUND

With the rapid growth of data services, a data transmission pressure on a carrier of a licensed spectrum is also increasing. Therefore, sharing data traffics in the licensed carrier through a carrier of an unlicensed spectrum becomes an important evolution direction of subsequent development of Long Term Evolution (LTE).

Unlicensed spectrum has the following characteristics: The unlicensed spectrum does not need to be purchased, and spectrum resources have no cost, therefore the unlicensed spectrum has free/low-cost characteristics. Both individuals and enterprises may participate in deployment, device vendors may deploy any device as desired, that is, the unlicensed spectrum has the characteristics of low access requirement and low cost. Frequency bands such as 5 GHz, 2.4 GHz and the like in the unlicensed spectrum can be used, therefore the unlicensed spectrum has the characteristic of large available bandwidth. Unlicensed carriers have the characteristics of resource sharing, that is, when a plurality of different systems operate therein or different operators of the same system operate therein, some resource sharing modes may be taken into consideration to improve spectrum utilization efficiency.

Based on the above characteristics of the unlicensed spectrum, the group starts researching a Rel-13 version of an LTE system in September, 2014. One of the important research topics is the use of unlicensed spectrum carriers for LTE systems. This technology will enable the LTE system to use currently existing unlicensed spectrum carriers, which will greatly increase potential spectrum resources of the LTE system and enable the LTE system to obtain a lower spectrum cost.

In addition to various benefits brought by unlicensed carriers in LTE systems, an important challenge that an LAA system has to face is fair coexistence between LTE LAA and other technologies such as Wireless-Fidelity (Wi-Fi). In addition, for the access of an unlicensed spectrum, regulatory requirements in some regions require to execute a Listen Before Talk (LBT) mechanism. Therefore, an LAA device such as a base station (e.g., an evolved Node B (eNB)) and/or User Equipment (UE) needs to comply with the LBT requirements, so as to achieve friendly coexistence with a Wi-Fi system.

Further, as a R13 LAA SI stage makes in-depth research on issues of LTE Advanced in Unlicensed Spectrums (LTE-U), eventually in a first session of a WI stage (3GPP RAN1 #82), a consensus on whether a UE needs to execute an LBT mechanism before uplink transmission has been reached. That is, major manufactures believe that the UE should execute the LBT mechanism independently, so as to enhance the uplink system performance. Meanwhile, it is also considered that a contention-based access mechanism used for uplink should be an LBT Cat2 and/or LBT Cat4 mechanism (Specifically, if a minimum contention window CWmin and a maximum contention window CWmax of LBT Cat4 are equal, Cat4 will degenerate to Cat3, and if a random backoff value in the Cat4 mechanism is 0, Cat4 may degenerate to Cat2), where Cat2 represents an LBT mechanism without random backoff, Cat3 represents a random backoff LBT mechanism with an invariable contention window size, and Cat4 represents a random backoff LBT mechanism with a variable contention window size.

Although some consensuses have been reached for LAA uplink, but for problems concerning how to choose the sizes of resources available for executing LBT for different scheduling mechanisms, or concerning how to select LBT parameters such as different contention window sizes and a value n in a composition of a defer period for devices with different priority classes remain to be researched. The above problems, if not solved well, will directly affect whether an LAA device can fairly contend with a Wi-Fi system for access to an unlicensed carrier, and cause waste of allocated resources and uplink grant indication information, thereby affecting the performance of an uplink system.

### SUMMARY

In order to solve the above technical problem, some embodiments of the disclosure provide a method and apparatus for configuring contention-based access parameters of an LAA device, which solves problems that an LAA system does not distinguish LBT parameters with different priority classes in a large congestion environment, resulting in that the LAA system executes contention-based access to an unlicensed carrier by using LBT parameters corresponding to a higher priority Quality of Service (QoS) class than the Wi-Fi system and therefore a contention-based access opportunity is low. In addition, problems of waste of uplink allocation resources and grant indication information, low spectrum efficiency and the like are improved.

A method for configuring contention-based access parameters of an LAA device provided in an embodiment of the disclosure includes the acts as follows.

According to different priority classes, different LBT mechanisms or different LBT mechanism parameter sets corresponding to the different priority classes are determined.

Contention-based access to an unlicensed carrier is executed by using the different LBT mechanisms or the different LBT mechanism parameter sets corresponding to the different priority classes.

When a right of using the unlicensed carrier is successfully gained based on a used LBT mechanism or a used LBT mechanism parameter set, data is transmitted by utilizing the unlicensed carrier.

In the embodiment of the disclosure, the different priority classes include:

priority classes classified according to different channels and/or different signals and/or different logical channels; or

priority classes classified according to different service types.

In the embodiment of the disclosure, logical channels having different priority classes are mapped to corresponding physical transmission channels, so that the physical transmission channels have corresponding priority classes.

In the embodiment of the disclosure, the different LBT mechanisms include: an LBT mechanism without random backoff, and an LBT mechanism with random backoff.

In the embodiment of the disclosure, the LBT mechanism without random backoff includes an LBT Cat2 mechanism or an enhanced LBT Cat2 mechanism.

In the embodiment of the disclosure, the LBT Cat2 mechanism is an LBT mechanism in which Clear Channel Assessment (CCA) is performed only once.

In the embodiment of the disclosure, the enhanced LBT Cat2 mechanism is an LBT mechanism in which there are a plurality of opportunities for performing CCA.

In the embodiment of the disclosure, the LBT mechanism with random backoff includes an LBT Cat4 mechanism or an LBT Cat3 mechanism.

Herein, a contention window size of the LBT Cat3 mechanism is invariable, and a contention window size of the LBT Cat4 mechanism is variable.

In the embodiment of the disclosure, parameters of the LBT Cat4 mechanism include: a first CCA, a defer period, a maximum contention window CWmax, a minimum contention window CWmin, and a random backoff value N.

In the embodiment of the disclosure, a composition of the defer period includes: defer time+n×slot, or, n×slot+defer time, where n is a number greater than or equal to 0 and smaller than 7, a slot duration is 9 us, and the defer time is configured as 16 us.

In the embodiment of the disclosure, a duration of the first CCA is one of the following: 34 us, 25 us, 20 us, 16 us, 9 us or 4 us.

In the embodiment of the disclosure, the random backoff value N is obtained by one of the following modes:

a base station indication mode, or a random generation mode, or a preset mode.

In the embodiment of the disclosure, a process of randomly generating the random backoff value N includes:

the random backoff value N is a random number generated within a range of [0, q−1],

where q is a random number generated within a range of [CWmin, CWmax].

In the embodiment of the disclosure, the LBT mechanism parameter set includes:

an LBT Cat2 mechanism parameter set, or an LBT Cat4 mechanism parameter set, or an LBT Cat2 and LBT Cat4 mechanism parameter set.

In the embodiment of the disclosure, the LBT Cat2 mechanism parameter set is a parameter set of different CCA durations, and elements in the LBT Cat2 mechanism parameter set only include CCA durations,

wherein different CCA durations are 34 us, 25 us, 20 us, 18 us, 16 us, 9 us, and 4 us.

In the embodiment of the disclosure, elements in the LBT Cat4 mechanism parameter set include CWmin, CWmax, and n in a composition of a defer period.

In the embodiment of the disclosure, the LBT Cat2 and LBT Cat4 mechanism parameter set is:

an LBT Cat2 mechanism parameter set comprising different CCA durations, and/or, an LBT Cat4 mechanism parameter set in which CWmin, CWmax and n in a composition of a defer period are configured with different values.

In the embodiment of the disclosure, the different LBT mechanism parameter sets corresponding to the different priority classes are: different CCA durations in an LBT Cat2 mechanism corresponding to the different priority classes, specifically including:

when priority classes corresponding to channels and/or signals and/or logical channels are increased sequentially, corresponding CCA durations in an LBT Cat2 mechanism are shortened sequentially; or,

when priority classes corresponding to service types are increased sequentially, corresponding CCA durations in an LBT Cat2 mechanism are shortened sequentially.

In the embodiment of the disclosure, the different LBT mechanism parameter sets corresponding to the different priority classes are: different element values in an LBT Cat4 mechanism parameter set corresponding to the different priority classes, specifically including:

when priority classes corresponding to channels and/or signals and/or logical channels are increased sequentially, corresponding value ranges of CWmin and CWmax in an LBT Cat4 mechanism parameter set are decreased sequentially, and corresponding values of n in a composition of a defer period are decreased sequentially along with sequential increase of the priority classes, or are equal to the same values; or,

when priority classes corresponding to service types are increased sequentially, corresponding value ranges of CWmin and CWmax in an LBT Cat4 mechanism parameter set are decreased sequentially, and corresponding values of n in a composition of a defer period are decreased sequentially along with sequential increase of the priority classes, or are equal to the same values.

In the embodiment of the disclosure, the different LBT mechanism parameter sets corresponding to the different priority classes are: LBT Cat2 and LBT Cat4 mechanism parameter sets corresponding to the different priority classes, specifically including:

when priority classes corresponding to channels and/or signals and/or logical channels are increased sequentially, corresponding LBT processes are simplified sequentially; or,

when priority classes corresponding to service types are increased sequentially, corresponding LBT processes are simplified sequentially.

In the embodiment of the disclosure, the operation that the LBT process is simplified sequentially includes: a highest priority class corresponds to LBT Cat2, a second highest priority class corresponds to enhanced LBT Cat2, and lowering priority classes correspond to LBT Cat3 and LBT Cat4 sequentially.

In the embodiment of the disclosure, the operation that the LBT process is simplified sequentially may further include:

the highest priority class corresponds to a short CCA duration in an LBT Cat2 mechanism, and lowering priority classes sequentially correspond to longer CCA durations in the LBT Cat2 mechanism, and an LBT Cat4 mechanism with an increased contention window and/or invariable or increased n.

In the embodiment of the disclosure, when the contention-based access to the unlicensed carrier is executed unsuccessfully/successfully by using an LBT mechanism parameter set corresponding to a current priority class, the method may further include one of the acts as follows.

An LBT mechanism or LBT mechanism parameter set corresponding to a priority class higher/lower than that of the LBT mechanism or LBT mechanism parameter set used in the unsuccessfully/successfully executed contention-based access is selected for a next contention-based access; or,

when contention-based access to a channel according to an LBT mechanism or LBT mechanism parameter set is executed unsuccessfully for a first preset threshold number of times, an LBT mechanism parameter set with a smaller contention window and/or a shorter CCA duration or a simpler or faster LBT mechanism is selected for the contention-based access to the channel; or,

when contention-based access to a channel according to an LBT mechanism or LBT mechanism parameter set is executed successfully for a second preset threshold number of times, an LBT mechanism parameter set with a larger contention window and/or a longer CCA duration or an LBT mechanism with a more complicated process is selected for the contention-based access to the channel; or,

a priority class is increased or decreased according to a measured interference variable.

In the embodiment of the disclosure, the method may further include the acts as follows.

When a plurality of different priority classes are present in one transmission burst or one subframe, LBT parameters are configured as follows:

an LBT parameter corresponding to the highest priority class is used as an LBT execution parameter in the transmission burst or the subframe; or,

an LBT mechanism is executed according to LBT parameters corresponding to different priority classes respectively to contend for the right of using the unlicensed carrier; or,

an LBT parameter corresponding to the lowest priority class is used as an LBT execution parameter in the transmission burst or the subframe.

In the embodiment of the disclosure, for different scheduling mechanisms, LBT parameters corresponding to different priority classes include:

LBT parameters for self-scheduling and cross-carrier scheduling under a same priority class are configured to be the same or different.

In the embodiment of the disclosure, the operation that LBT parameters for the self-scheduling and the cross-carrier scheduling under the same priority class are configured to be different includes:

under the same priority class, the self-scheduling corresponds to one set of LBT parameter set values, while the cross-carrier scheduling corresponds to another set of LBT parameter set values.

In the embodiment of the disclosure, the LBT priority class is determined by one of the following modes: a predefined mode, a service type-based mode, or a base station configuration mode.

In the embodiment of the disclosure, the LBT priority class includes: a base station determines that a QoS Class Identifier (QCI) has a mapping relationship with the LBT priority class.

In the embodiment of the disclosure, the mapping relationship between the QCI and the LBT priority class is determined by one of the following modes: a predefined mode; a base station and UE appointment mode; a base station determination mode; a terminal determination mode; a physical layer Downlink Control Information (DCI) signaling determination mode; or an upper-layer Radio Resource Control (RRC) signaling determination mode.

In the embodiment of the disclosure, at least one of a service type, a logical channel or logical channel group, delays of different data packets, different packet loss rates, service type priority classes, or the priority class of the logical channel or logical channel group has a correspondence with a QCI.

In the embodiment of the disclosure, the correspondence between the QCI and at least one of the service type, the logical channel or logical channel group, the delays of different data packets, the different packet loss rates, the service type priority classes, or the priority class of the logical channel or logical channel group is determined by one of the following modes: a predefined mode; a base station and UE appointment mode; a base station determination mode; a terminal determination mode; a physical layer DCI signaling determination mode; or an upper-layer RRC signaling determination mode.

In the embodiment of the disclosure, at least one of the following is included: different logical channels correspond to different LBT priority classes; different service types correspond to different LBT priority classes; different logical channels correspond to different QCIs, different service types correspond to different QCIs, LBT priority classes corresponding to different logical channels are determined based on a correspondence between a QCI and different logical channels and a correspondence between the QCI and LBT priority classes; or LBT priority classes corresponding to different logical channels are determined based on a correspondence between a QCI and different service types and a correspondence between the QCI and LBT priority classes.

In the embodiment of the disclosure, for a retransmission data packet, the contention-based access is performed by using an LBT mechanism or LBT mechanism parameter set corresponding to a priority class higher than an initial priority class.

An apparatus for configuring contention-based access parameters of an LAA device provided in another embodiment of the disclosure includes:

a determination unit, configured to determine, according to different priority classes, different LBT mechanisms or different LBT mechanism parameter sets corresponding to the different priority classes;

an execution unit, configured to execute contention-based access to an unlicensed carrier by using the different LBT mechanisms or the different LBT mechanism parameter sets corresponding to the different priority classes; and

a transmission unit, configured to transmit, when a right of using the unlicensed carrier is successfully gained based on a used LBT mechanism or a used LBT mechanism parameter set, data by utilizing the unlicensed carrier.

In the embodiment of the disclosure, the different priority classes include:

priority classes classified according to different channels and/or different signals and/or different logical channels; or

priority classes classified according to different service types.

In the embodiment of the disclosure, logical channels having different priority classes are mapped to corresponding physical transmission channels, so that the physical transmission channels have corresponding priority classes.

In the embodiment of the disclosure, the different LBT mechanisms include:

an LBT mechanism without random backoff, and an LBT mechanism with random backoff.

In the embodiment of the disclosure, the LBT mechanism without random backoff includes an LBT Cat2 mechanism or an enhanced LBT Cat2 mechanism.

In the embodiment of the disclosure, the LBT Cat2 mechanism is an LBT mechanism in which CCA is performed only once.

In the embodiment of the disclosure, the enhanced LBT Cat2 mechanism is an LBT mechanism in which there are a plurality of opportunities for performing CCA.

In the embodiment of the disclosure, the LBT mechanism with random backoff includes an LBT Cat4 mechanism or an LBT Cat3 mechanism.

Herein, a contention window size of the LBT Cat3 mechanism is invariable, and a contention window size of the LBT Cat4 mechanism is variable.

In the embodiment of the disclosure, parameters of the LBT Cat4 mechanism include: a first CCA, a defer period, a maximum contention window CWmax, a minimum contention window CWmin, and a random backoff value N.

In the embodiment of the disclosure, a composition of the defer period includes: defer time+n×slot, or, n×slot+defer time,

where n is a number greater than or equal to 0 and smaller than 7, a slot duration is 9 us, and the defer time is configured as 16 us.

In the embodiment of the disclosure, a duration of the first CCA is one of the following: 34 us, 25 us, 20 us, 16 us, 9 us or 4 us.

In the embodiment of the disclosure, the determination unit is further configured to obtain the random backoff value N by one of the following modes: a base station indication mode, or a random generation mode, or a preset mode.

In the embodiment of the disclosure, the determination unit is further configured to randomly generate the random backoff value N by the following process: the random backoff value N is a random number generated within a range of [0, q−1], where q is a random number generated within a range of [CWmin, CWmax].

In the embodiment of the disclosure, the LBT mechanism parameter set includes: an LBT Cat2 mechanism parameter set, or an LBT Cat4 mechanism parameter set, or an LBT Cat2 and LBT Cat4 mechanism parameter set.

In the embodiment of the disclosure, the LBT Cat2 mechanism parameter set is a parameter set of different CCA durations, and elements in the LBT Cat2 mechanism parameter set only include CCA durations,

wherein different CCA durations are 34 us, 25 us, 20 us, 18 us, 16 us, 9 us, and 4 us.

In the embodiment of the disclosure, elements in the LBT Cat4 mechanism parameter set include CWmin, CWmax, and n in a composition of a defer period.

In the embodiment of the disclosure, the LBT Cat2 and LBT Cat4 mechanism parameter set is:

an LBT Cat2 mechanism parameter set comprising different CCA durations, and/or, an LBT Cat4 mechanism parameter set in which CWmin, CWmax and n in a composition of a defer period are configured with different values.

In the embodiment of the disclosure, the different LBT mechanism parameter sets corresponding to the different priority classes are: different CCA durations in an LBT Cat2 mechanism corresponding to the different priority classes; and the determination unit is further configured to: sequentially shorten, when priority classes corresponding to channels and/or signals and/or logical channels are increased sequentially, corresponding CCA durations in an LBT Cat2 mechanism; or, sequentially shorten, when priority classes corresponding to service types are increased sequentially, corresponding CCA durations in an LBT Cat2 mechanism.

In the embodiment of the disclosure, the different LBT mechanism parameter sets corresponding to the different priority classes are: different element values in an LBT Cat4 mechanism parameter set corresponding to the different priority classes; and the determination unit is further configured to: sequentially decrease, when priority classes corresponding to channels and/or signals and/or logical channels are increased sequentially, corresponding value ranges of CWmin and CWmax in an LBT Cat4 mechanism parameter set, wherein corresponding values of n in a composition of a defer period are decreased sequentially along with sequential increase of the priority classes, or are equal to the same values; or, sequentially decrease, when priority classes corresponding to service types are increased sequentially, corresponding value ranges of CWmin and CWmax in an LBT Cat4 mechanism parameter set, wherein corresponding values of n in a composition of a defer period are decreased sequentially along with sequential increase of the priority classes, or are equal to the same values.

In the embodiment of the disclosure, the different LBT mechanism parameter sets corresponding to the different priority classes are: LBT Cat2 and LBT Cat4 mechanism parameter sets corresponding to the different priority classes; and the determination unit is further configured to: sequentially simplify, when priority classes corresponding to channels and/or signals and/or logical channels are increased sequentially, a corresponding LBT process; or, sequentially simplify, when priority classes corresponding to service types are increased sequentially, a corresponding LBT process.

In the embodiment of the disclosure, the operation that the LBT process is simplified sequentially includes: a highest priority class corresponds to LBT Cat2, a second highest priority class corresponds to enhanced LBT Cat2, and lowering priority classes correspond to LBT Cat3 and LBT Cat4 sequentially.

In the embodiment of the disclosure, the operation that the LBT process is simplified sequentially may further include:

the highest priority class corresponds to a short CCA duration in an LBT Cat2 mechanism, and lowering priority classes sequentially correspond to longer CCA durations in the LBT Cat2 mechanism, and an LBT Cat4 mechanism with an increased contention window and/or invariable or increased n.

In the embodiment of the disclosure, the determination unit is further configured to: select, when the contention-based access to the unlicensed carrier is executed unsuccessfully/successfully by using an LBT mechanism parameter set corresponding to a current priority class, for a next contention-based access an LBT mechanism or LBT mechanism parameter set corresponding to a priority class higher/lower than that of the LBT mechanism or LBT mechanism parameter set used in the unsuccessfully/successfully executed contention-based access; or, select, when contention-based access to a channel according to an LBT mechanism or LBT mechanism parameter set is executed unsuccessfully for a first preset threshold number of times, for the contention-based access to the channel an LBT mechanism parameter set with a smaller contention window and/or a shorter CCA duration or a simpler or faster LBT mechanism; or, select, when contention-based access to a channel according to an LBT mechanism or LBT mechanism parameter set is executed successfully for a second preset threshold number of times, for the contention-based access to the channel an LBT mechanism parameter set with a larger contention window and/or a longer CCA duration or an LBT mechanism with a more complicated process; or, increase or decrease a priority class according to a measured interference variable.

In the embodiment of the disclosure, the determination unit is further configured to: configure, when a plurality of different priority classes are present in one transmission burst or one subframe, LBT parameters as follows: an LBT parameter corresponding to the highest priority class is used as an LBT execution parameter in the transmission burst or the subframe; or, an LBT mechanism is executed according to LBT parameters corresponding to different priority classes respectively to contend for the right of using the unlicensed carrier; or, an LBT parameter corresponding to the lowest priority class is used as an LBT execution parameter in the transmission burst or the subframe.

In the embodiment of the disclosure, for different scheduling mechanisms, LBT parameters corresponding to different priority classes include: LBT parameters for self-scheduling and cross-carrier scheduling under a same priority class are configured to be the same or different.

In the embodiment of the disclosure, the operation that LBT parameters for the self-scheduling and the cross-carrier scheduling under the same priority class are configured to be different includes: under the same priority class, the self-scheduling corresponds to one set of LBT parameter set values, while the cross-carrier scheduling corresponds to another set of LBT parameter set values.

In the embodiment of the disclosure, the determination unit is further configured to perform, for a retransmission data packet, the contention-based access by using an LBT mechanism or LBT mechanism parameter set corresponding to a priority class higher than an initial priority class.

In the embodiment of the disclosure, the LBT priority class is determined by one of the following modes: a predefined mode, a service type-based mode, or a base station configuration mode.

In the embodiment of the disclosure, the LBT priority class includes: a base station determines that a QCI has a mapping relationship with the LBT priority class.

In the embodiment of the disclosure, the mapping relationship between the QCI and the LBT priority class is determined by one of the following modes: a predefined mode; a base station and UE appointment mode; a base station determination mode; a terminal determination mode; a physical layer DCI signaling determination mode; or an upper-layer RRC signaling determination mode.

In the embodiment of the disclosure,

at least one of a service type, a logical channel or logical channel group, delays of different data packets, different packet loss rates, service type priority classes, or the priority class of the logical channel or logical channel group has a correspondence with a QCI.

In the embodiment of the disclosure, the correspondence between the QCI and at least one of the service type, the logical channel or logical channel group, the delays of different data packets, the different packet loss rates, the service type priority classes, or the priority class of the logical channel or logical channel group is determined by one of the following modes: a predefined mode; a base station and UE appointment mode; a base station determination mode; a terminal determination mode; a physical layer DCI signaling determination mode; or an upper-layer RRC signaling determination mode.

In the embodiment of the disclosure, at least one of the following is included: different logical channels correspond to different LBT priority classes; different service types correspond to different LBT priority classes; different logical channels correspond to different QCIs, different service types correspond to different QCIs, LBT priority classes corresponding to different logical channels are determined based on a correspondence between a QCI and different logical channels and a correspondence between the QCI and LBT priority classes; or LBT priority classes corresponding to different logical channels are determined based on a correspondence between a QCI and different service types and a correspondence between the QCI and LBT priority classes.

Another embodiment of the disclosure provides a computer storage medium which stores an executable instruction, the executable instruction being used to execute the method in the above embodiment.

In the technical solutions of the embodiments of the disclosure, according to different priority classes, different LBT mechanisms or different LBT mechanism parameter sets corresponding to the different priority classes are determined; contention-based access to an unlicensed carrier is executed by using the different LBT mechanisms or the different LBT mechanism parameter sets corresponding to the different priority classes; and when a right of using the unlicensed carrier is successfully gained based on a used LBT mechanism or a used LBT mechanism parameter set, data is transmitted by utilizing the unlicensed carrier. By virtue of the solution, problems that an LAA system does not distinguish LBT parameters with different priority classes in a large congestion environment, resulting in that the LAA system executes contention-based access to an unlicensed carrier by using LBT parameters corresponding to a high-priority QoS class and a contention-based access opportunity is low are solved. In addition, problems of waste of uplink allocation resources and grant indication information, low spectrum efficiency and the like are further addressed.

### BRIEF DESCRIPTION OF THE DRAWINGS

FIG. 1 is a flowchart of a method for configuring contention-based access parameters of an LAA device according to an embodiment of the disclosure;

FIG. 2 is a structure composition diagram of an apparatus for configuring contention-based access parameters of an LAA device according to an embodiment of the disclosure;

FIG. 3(a) is a schematic diagram illustrating that an LAA UE executes LBT under a self-scheduling mode according to an embodiment of the disclosure; and

FIG. 3(b) is a schematic diagram illustrating that an LAA UE executes LBT under a cross-carrier scheduling mode according to an embodiment of the disclosure.

### DETAILED DESCRIPTION OF THE EMBODIMENTS

In order to more fully understand the features and technical contents of the embodiments of the disclosure, the following describes the implementation of the embodiments of the disclosure in detail with reference to the accompanying drawings. The attached drawings are only for reference and description, and are not intended to limit the embodiments of the disclosure.

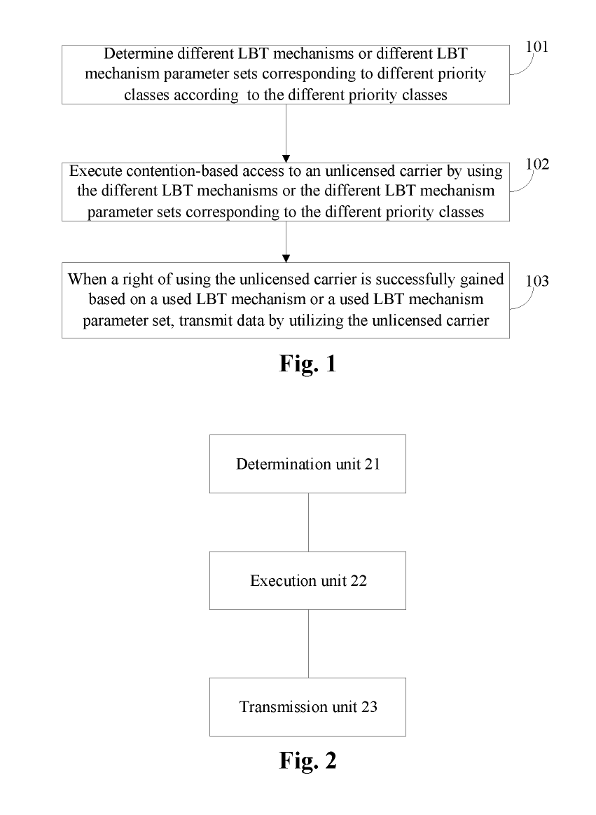

FIG. 1 is a flowchart of a method for configuring contention-based access parameters of an LAA device according to an embodiment of the disclosure. As shown in FIG. 1, the method for configuring contention-based access parameters of an LAA device provided in the embodiment of the disclosure includes the acts S101 to S 103 as follows.

At S101, according to different priority classes, different LBT mechanisms or different LBT mechanism parameter sets corresponding to the different priority classes are determined.

In the embodiment of the disclosure, the different priority classes include:

priority classes classified according to different channels and/or different signals and/or different logical channels; or,

priority classes classified according to different service types.

In the embodiment of the disclosure, logical channels having different priority classes are mapped to corresponding physical transmission channels, so that the physical transmission channels have corresponding priority classes.

In the embodiment of the disclosure, the different LBT mechanisms include:

an LBT mechanism without random backoff, and an LBT mechanism with random backoff.

In the embodiment of the disclosure, the LBT mechanism without random backoff includes an LBT Cat2 mechanism or an enhanced LBT Cat2 mechanism.

In the embodiment of the disclosure, the LBT Cat2 mechanism is an LBT mechanism in which CCA is performed only once.

In the embodiment of the disclosure, the enhanced LBT Cat2 mechanism is an LBT mechanism in which there are a plurality of opportunities for performing CCA.

In the embodiment of the disclosure, the LBT mechanism with random backoff includes an LBT Cat4 mechanism or an LBT Cat3 mechanism.

Herein, a contention window size of the LBT Cat3 mechanism is invariable, and a contention window size of the LBT Cat4 mechanism is variable.

In the embodiment of the disclosure, parameters of the LBT Cat4 mechanism include: a first CCA, a defer period, a maximum contention window CWmax, a minimum contention window CWmin, and a random backoff value N.

In the embodiment of the disclosure, a composition of the defer period includes: defer time+n×slot, or, n×slot+defer time,

where n is a number greater than or equal to 0 and smaller than 7, a slot duration is 9 us, and the defer time is configured as 16 us.

In the embodiment of the disclosure, a duration of the first CCA is one of the following: 34 us, 25 us, 20 us, 16 us, 9 us or 4 us.

In the embodiment of the disclosure, the random backoff value N is obtained by one of the following modes:

a base station indication mode, or a random generation mode, or a preset mode.

In the embodiment of the disclosure, a process of randomly generating the random backoff value N includes:

the random backoff value N is a random number generated within a range of [0, q−1],

where q is a random number generated within a range of [CWmin, CWmax].

In the embodiment of the disclosure, the LBT mechanism parameter set includes: an LBT Cat2 mechanism parameter set, or an LBT Cat4 mechanism parameter set, or an LBT Cat2 and LBT Cat4 mechanism parameter set.

In the embodiment of the disclosure, the LBT Cat2 mechanism parameter set is a parameter set of different CCA durations, and elements in the LBT Cat2 mechanism parameter set only include CCA durations,

wherein different CCA durations are 34 us, 25 us, 20 us, 18 us, 16 us, 9 us, and 4 us.

In the embodiment of the disclosure, elements in the LBT Cat4 mechanism parameter set include CWmin, CWmax, and n in a composition of a defer period.

In the embodiment of the disclosure, the LBT Cat2 and LBT Cat4 mechanism parameter set is:

an LBT Cat2 mechanism parameter set comprising different CCA durations, and/or, an LBT Cat4 mechanism parameter set in which CWmin, CWmax and n in a composition of a defer period are configured with different values.

In the embodiment of the disclosure, the different LBT mechanism parameter sets corresponding to the different priority classes are: different CCA durations in an LBT Cat2 mechanism corresponding to the different priority classes, specifically including:

when priority classes corresponding to channels and/or signals and/or logical channels are increased sequentially, corresponding CCA durations in an LBT Cat2 mechanism are shortened sequentially; or,

when priority classes corresponding to service types are increased sequentially, corresponding CCA durations in an LBT Cat2 mechanism are shortened sequentially.

In the embodiment of the disclosure, the different LBT mechanism parameter sets corresponding to the different priority classes are: different element values in an LBT Cat4 mechanism parameter set corresponding to the different priority classes, specifically including:

when priority classes corresponding to channels and/or signals and/or logical channels are increased sequentially, corresponding value ranges of CWmin and CWmax in an LBT Cat4 mechanism parameter set are decreased sequentially, and corresponding values of n in a composition of a defer period are decreased sequentially along with sequential increase of the priority classes, or are equal to the same values; or,

when priority classes corresponding to service types are increased sequentially, corresponding value ranges of CWmin and CWmax in an LBT Cat4 mechanism parameter set are decreased sequentially, and corresponding values of n in a composition of a defer period are decreased sequentially along with sequential increase of the priority classes, or are equal to the same values.

In the embodiment of the disclosure, the different LBT mechanism parameter sets corresponding to the different priority classes are: LBT Cat2 and LBT Cat4 mechanism parameter sets corresponding to the different priority classes, specifically including:

when priority classes corresponding to channels and/or signals and/or logical channels are increased sequentially, corresponding LBT processes are simplified sequentially; or,

when priority classes corresponding to service types are increased sequentially, corresponding LBT processes are simplified sequentially.

In the embodiment of the disclosure, the operation that the LBT process is simplified sequentially includes: a highest priority class corresponds to LBT Cat2, a second highest priority class corresponds to enhanced LBT Cat2, and lowering priority classes correspond to LBT Cat3 and LBT Cat4 sequentially.

In the embodiment of the disclosure, the operation that the LBT process is simplified sequentially may further include:

the highest priority class corresponds to a short CCA duration in an LBT Cat2 mechanism, and lowering priority classes sequentially correspond to longer CCA durations in the LBT Cat2 mechanism, and an LBT Cat4 mechanism with an increased contention window and/or invariable or increased n.

In the embodiment of the disclosure, when the contention-based access to the unlicensed carrier is executed unsuccessfully/successfully by using an LBT mechanism parameter set corresponding to a current priority class, the method may further include one of the acts as follows.

An LBT mechanism or LBT mechanism parameter set corresponding to a priority class higher/lower than that of the LBT mechanism or LBT mechanism parameter set used in the unsuccessfully/successfully executed contention-based access is selected for a next contention-based access; or,

when contention-based access to a channel according to an LBT mechanism or LBT mechanism parameter set is executed unsuccessfully for a first preset threshold number of times, an LBT mechanism parameter set with a smaller contention window and/or a shorter CCA duration or a simpler or faster LBT mechanism is selected for the contention-based access to the channel; or,

when contention-based access to a channel according to an LBT mechanism or LBT mechanism parameter set is executed successfully for a second preset threshold number of times, an LBT mechanism parameter set with a larger contention window and/or a longer CCA duration or an LBT mechanism with a more complicated process is selected for the contention-based access to the channel; or,

a priority class is increased or decreased according to a measured interference variable.

At S102, contention-based access to an unlicensed carrier is executed by using the different LBT mechanisms or the different LBT mechanism parameter sets corresponding to the different priority classes.

At S103, when a right of using the unlicensed carrier is successfully gained based on a used LBT mechanism or a used LBT mechanism parameter set, data is transmitted by utilizing the unlicensed carrier.

In the embodiment of the disclosure, the method may further include the acts as follows.

When a plurality of different priority classes are present in one transmission burst or one subframe, LBT parameters are configured as follows:

an LBT parameter corresponding to the highest priority class is used as an LBT execution parameter in the transmission burst or the subframe; or,

an LBT mechanism is executed according to LBT parameters corresponding to different priority classes respectively to contend for the right of using the unlicensed carrier; or,

an LBT parameter corresponding to the lowest priority class is used as an LBT execution parameter in the transmission burst or the subframe.

In the embodiment of the disclosure, for different scheduling mechanisms, LBT parameters corresponding to different priority classes include:

LBT parameters for self-scheduling and cross-carrier scheduling under a same priority class are configured to be the same or different.

In the embodiment of the disclosure, the operation that LBT parameters for the self-scheduling and the cross-carrier scheduling under the same priority class are configured to be different includes:

under the same priority class, the self-scheduling corresponds to one set of LBT parameter set values, while the cross-carrier scheduling corresponds to another set of LBT parameter set values.

In the embodiment of the disclosure, for a retransmission data packet, the contention-based access is performed by using an LBT mechanism or LBT mechanism parameter set corresponding to a priority class higher than an initial priority class.

In the embodiment of the disclosure, the LBT priority class is determined by one of the following modes: a predefined mode, a service type-based mode, or a base station configuration mode.

In the embodiment of the disclosure, the LBT priority class includes: a base station determines that a QCI has a mapping relationship with the LBT priority class.

In the embodiment of the disclosure, the mapping relationship between the QCI and the LBT priority class is determined by one of the following modes: a predefined mode; a base station and UE appointment mode; a base station determination mode; a terminal determination mode; a physical layer DCI signaling determination mode; or an upper-layer RRC signaling determination mode.

In the embodiment of the disclosure, at least one of a service type, a logical channel or logical channel group, delays of different data packets, different packet loss rates, service type priority classes, or the priority class of the logical channel or logical channel group has a correspondence with a QCI. In the embodiment, the service type, the logical channel or logical channel group, the delays of different data packets, the different packet loss rates and the priority class of the logical channel or logical channel group may have a correspondence with the QCI individually, or may have a correspondence with the QCI in different combination modes.

In the embodiment of the disclosure, the correspondence between the QCI and at least one of the service type, the logical channel or logical channel group, the delays of different data packets, the different packet loss rates, the service type priority classes, or the priority class of the logical channel or logical channel group is determined by one of the following modes: a predefined mode; a base station and UE appointment mode; a base station determination mode; a terminal determination mode; a physical layer DCI signaling determination mode; or an upper-layer RRC signaling determination mode.

In the embodiment of the disclosure, at least one of the following is included: different logical channels correspond to different LBT priority classes; different service types correspond to different LBT priority classes; different logical channels correspond to different QCIs, different service types correspond to different QCIs, LBT priority classes corresponding to different logical channels are determined based on a correspondence between a QCI and different logical channels and a correspondence between the QCI and LBT priority classes; or LBT priority classes corresponding to different logical channels are determined based on a correspondence between a QCI and different service types and a correspondence between the QCI and LBT priority classes.

FIG. 2 is a structure composition diagram of an apparatus for configuring contention-based access parameters of an LAA device according to an embodiment of the disclosure. As shown in FIG. 2, the apparatus for configuring contention-based access parameters of an LAA device provided in the embodiment of the disclosure includes:

a determination unit 21, configured to determine, according to different priority classes, different LBT mechanisms or different LBT mechanism parameter sets corresponding to the different priority classes;

an execution unit 22, configured to execute contention-based access to an unlicensed carrier by using the different LBT mechanisms or the different LBT mechanism parameter sets corresponding to the different priority classes; and

a transmission unit 23, configured to transmit, when a right of using the unlicensed carrier is successfully gained based on a used LBT mechanism or a used LBT mechanism parameter set, data by utilizing the unlicensed carrier.

In the embodiment of the disclosure, the different priority classes include:

priority classes classified according to different channels and/or different signals and/or different logical channels; or,

priority classes classified according to different service types.

In the embodiment of the disclosure, logical channels having different priority classes are mapped to corresponding physical transmission channels, so that the physical transmission channels have corresponding priority classes.

In the embodiment of the disclosure, the different LBT mechanisms include:

an LBT mechanism without random backoff, and an LBT mechanism with random backoff.

In the embodiment of the disclosure, the LBT mechanism without random backoff includes an LBT Cat2 mechanism or an enhanced LBT Cat2 mechanism.

In the embodiment of the disclosure, the LBT Cat2 mechanism is an LBT mechanism in which CCA is performed only once.

In the embodiment of the disclosure, the enhanced LBT Cat2 mechanism is an LBT mechanism in which there are a plurality of opportunities for performing CCA.

In the embodiment of the disclosure, the LBT mechanism with random backoff includes an LBT Cat4 mechanism or an LBT Cat3 mechanism.

Herein, a contention window size of the LBT Cat3 mechanism is invariable, and a contention window size of the LBT Cat4 mechanism is variable.

In the embodiment of the disclosure, parameters of the LBT Cat4 mechanism include: a first CCA, a defer period, a maximum contention window CWmax, a minimum contention window CWmin, and a random backoff value N.

In the embodiment of the disclosure, a composition of the defer period includes: defer time+n×slot, or, n×slot+defer time,

where n is a number greater than or equal to 0 and smaller than 7, a slot duration is 9 us, and the defer time is configured as 16 us.

In the embodiment of the disclosure, a duration of the first CCA is one of the following: 34 us, 25 us, 20 us, 16 us, 9 us or 4 us.

In the embodiment of the disclosure, the determination unit 21 is further configured to obtain the random backoff value N by one of the following modes: a base station indication mode, or a random generation mode, or a preset mode.

In the embodiment of the disclosure, the determination unit 21 is further configured to randomly generate the random backoff value N by the following process: the random backoff value N is a random number generated within a range of [0, q−1], where q is a random number generated within a range of [CWmin, CWmax].

In the embodiment of the disclosure, the LBT mechanism parameter set includes: an LBT Cat2 mechanism parameter set, or an LBT Cat4 mechanism parameter set, or an LBT Cat2 and LBT Cat4 mechanism parameter set.

In the embodiment of the disclosure, the LBT Cat2 mechanism parameter set is a parameter set of different CCA durations, and elements in the LBT Cat2 mechanism parameter set only include CCA durations,

wherein different CCA durations are 34 us, 25 us, 20 us, 18 us, 16 us, 9 us, and 4 us.

In the embodiment of the disclosure, elements in the LBT Cat4 mechanism parameter set include CWmin, CWmax, and n in a composition of a defer period.

In the embodiment of the disclosure, the LBT Cat2 and LBT Cat4 mechanism parameter set is:

an LBT Cat2 mechanism parameter set comprising different CCA durations, and/or, an LBT Cat4 mechanism parameter set in which CWmin, CWmax and n in a composition of a defer period are configured with different values.

In the embodiment of the disclosure, the different LBT mechanism parameter sets corresponding to the different priority classes are: different CCA durations in an LBT Cat2 mechanism corresponding to the different priority classes, the determination unit being further configured to: sequentially shorten, when priority classes corresponding to channels and/or signals and/or logical channels are increased sequentially, corresponding CCA durations in an LBT Cat2 mechanism; or, sequentially shorten, when priority classes corresponding to service types are increased sequentially, corresponding CCA durations in an LBT Cat2 mechanism.

In the embodiment of the disclosure, the different LBT mechanism parameter sets corresponding to the different priority classes are: different element values in an LBT Cat4 mechanism parameter set corresponding to the different priority classes, the determination unit 21 being further configured to: sequentially decrease, when priority classes corresponding to channels and/or signals and/or logical channels are increased sequentially, corresponding value ranges of CWmin and CWmax in an LBT Cat4 mechanism parameter set, wherein corresponding values of n in a composition of a defer period are decreased sequentially along with sequential increase of the priority classes, or are equal to the same values; or, sequentially decrease, when priority classes corresponding to service types are increased sequentially, corresponding value ranges of CWmin and CWmax in an LBT Cat4 mechanism parameter set, wherein corresponding values of n in a composition of a defer period are decreased sequentially along with sequential increase of the priority classes, or are equal to the same values.

In the embodiment of the disclosure, the different LBT mechanism parameter sets corresponding to the different priority classes are: LBT Cat2 and LBT Cat4 mechanism parameter sets corresponding to the different priority classes, the determination unit 21 being further configured to: sequentially simplify, when priority classes corresponding to channels and/or signals and/or logical channels are increased sequentially, a corresponding LBT process; or, sequentially simplify, when priority classes corresponding to service types are increased sequentially, a corresponding LBT process.

In the embodiment of the disclosure, the operation that the LBT process is simplified sequentially is: a highest priority class corresponds to LBT Cat2, a second highest priority class corresponds to enhanced LBT Cat2, and lowering priority classes correspond to LBT Cat3 and LBT Cat4 sequentially.

In the embodiment of the disclosure, the operation that the LBT process is simplified sequentially is:

the highest priority class corresponds to a short CCA duration in an LBT Cat2 mechanism, and lowering priority classes sequentially correspond to longer CCA durations in the LBT Cat2 mechanism, and an LBT Cat4 mechanism with an increased contention window and/or invariable or increased n.

In the embodiment of the disclosure, the determination unit 21 is further configured to: select, when the contention-based access to the unlicensed carrier is executed unsuccessfully/successfully by using an LBT mechanism parameter set corresponding to a current priority class, for a next contention-based access an LBT mechanism or LBT mechanism parameter set corresponding to a priority class higher/lower than that of the LBT mechanism or LBT mechanism parameter set used in the unsuccessfully/successfully executed contention-based access; or, select, when contention-based access to a channel according to an LBT mechanism or LBT mechanism parameter set is executed unsuccessfully for a first preset threshold number of times, for the contention-based access to the channel an LBT mechanism parameter set with a smaller contention window and/or a shorter CCA duration or a simpler or faster LBT mechanism; select, when contention-based access to a channel according to an LBT mechanism or LBT mechanism parameter set is executed successfully for a second preset threshold number of times, for the contention-based access to the channel an LBT mechanism parameter set with a larger contention window and/or a longer CCA duration or an LBT mechanism with a more complicated process; or, increase or decrease a priority class according to a measured interference variable.

In the embodiment of the disclosure, the determination unit 21 is further configured to: configure, when a plurality of different priority classes are present in one transmission burst or one subframe, LBT parameters as follows: an LBT parameter corresponding to the highest priority class is used as an LBT execution parameter in the transmission burst or the subframe; or, an LBT mechanism is executed according to LBT parameters corresponding to different priority classes respectively to contend for the right of using the unlicensed carrier; or, an LBT parameter corresponding to the lowest priority class is used as an LBT execution parameter in the transmission burst or the subframe.

In the embodiment of the disclosure, for different scheduling mechanisms, LBT parameters corresponding to different priority classes include: LBT parameters for self-scheduling and cross-carrier scheduling under a same priority class are configured to be the same or different.

In the embodiment of the disclosure, the operation that LBT parameters for the self-scheduling and the cross-carrier scheduling under the same priority class are configured to be different includes: under the same priority class, the self-scheduling corresponds to one set of LBT parameter set values, while the cross-carrier scheduling corresponds to another set of LBT parameter set values.

In the embodiment of the disclosure, the determination unit 21 is further configured to perform, for a retransmission data packet, the contention-based access by using an LBT mechanism or LBT mechanism parameter set corresponding to a priority class higher than an initial priority class.

In the embodiment of the disclosure, the LBT priority class is determined by one of the following modes: a predefined mode, a service type-based mode, or a base station configuration mode.

In the embodiment of the disclosure, the LBT priority class includes: a base station determines that a QCI has a mapping relationship with the LBT priority class.

In the embodiment of the disclosure, the mapping relationship between the QCI and the LBT priority class is determined by one of the following modes: a predefined mode; a base station and UE appointment mode; a base station determination mode; a terminal determination mode; a physical layer DCI signaling determination mode; or an upper-layer RRC signaling determination mode.

In the embodiment of the disclosure, at least one of a service type, a logical channel or logical channel group, delays of different data packets, different packet loss rates, service type priority classes, or the priority class of the logical channel or logical channel group has a correspondence with a QCI.

In the embodiment of the disclosure, the correspondence between the QCI and at least one of the service type, the logical channel or logical channel group, the delays of different data packets, the different packet loss rates, the service type priority classes, or the priority class of the logical channel or logical channel group is determined by one of the following modes: a predefined mode; a base station and UE appointment mode; a base station determination mode; a terminal determination mode; a physical layer DCI signaling determination mode; or an upper-layer RRC signaling determination mode.

In the embodiment of the disclosure, at least one of the following is included: different logical channels correspond to different LBT priority classes; different service types correspond to different LBT priority classes; different logical channels correspond to different QCIs, different service types correspond to different QCIs, LBT priority classes corresponding to different logical channels are determined based on a correspondence between a QCI and different logical channels and a correspondence between the QCI and LBT priority classes; or LBT priority classes corresponding to different logical channels are determined based on a correspondence between a QCI and different service types and a correspondence between the QCI and LBT priority classes.

The method for configuring contention-based access parameters of an LAA device according to the embodiment of the disclosure is further described in detail below in conjunction with a specific application scenario. (The method provided in the embodiment of the disclosure is also applicable to downlink.)

If an LAA device executes, before performing transmission on an unlicensed carrier, an LBT mechanism by using the same or uniform set of parameters (e.g., using LBT parameters for a lowest-priority class) without distinguishing different priority classes, i.e., not through different QoS classes or, different channels and/or signals and/or logical channel priority classes corresponding to different LBT mechanisms and/or LBT mechanism parameter set configurations, high-priority class devices/service types/channels/signals will have higher/more channel access opportunities, or highest-priority class transmission services and/or channels and/or signals and/or logical channels perform channel access by using an LBT mechanism or LBT mechanism parameter set corresponding to a lower priority class, thereby resulting in missed channel access. Based on this, if an LTE system appears to be too conservative compared to a Wi-Fi system using LBT parameters corresponding to a high-priority QoS class for channel contention-based access in the case of large congestion, it is disadvantageous for contention-based access and channel occupancy of the LTE system on an unlicensed carrier. Therefore, the LTE system operating on the unlicensed carrier only uses LBT parameters for a lowest-priority class, which makes it unreasonable and needs to support different priority classes corresponding to different LBT mechanisms and/or LBT mechanism parameter set configurations.

### First Embodiment

The present embodiment mainly describes a method of classifying different priority classes, wherein different priority classes are classified as follows. One is to classify different priority classes according to different service types. The other one is to classify different priority classes according to signals and/or channels and/or logical channels. In addition, according to different priority classes, a corresponding LBT mechanism and/or an LBT mechanism parameter set under the used LBT mechanism during execution of an LBT process can be known.

Preferably, according to different priority classification methods, different priority classes correspond to different LBT mechanisms and/or parameter sets, or, correspond to different element values in a parameter set under a specific LBT mechanism, wherein for a mode of classifying different priority classes according to signals and/or channels and/or logical channels, a certain priority class may include at least one of the following: signals, channels, and logical channels, wherein for uplink, the signal may include: a Sounding Reference Signal (SRS). The channels may include a Physical Uplink Shared Channel (PUSCH), a Physical Uplink Control Channel (PUCCH), and a Physical Random Access Channel (PRACH). The logical channels include: a Common Control Channel (CCCH), a Dedicated Control Channel (DCCH), and a Dedicated Traffic Channel (DTCH). In addition, the logical channels have a certain priority class, so that when a logical channel is mapped onto a corresponding physical transmission channel, the physical transmission channel also has different priority classes with different logical channel priority classes. For downlink, downlink signals and/or channels and/or logical channels in the existing LTE are also suitable for this and the foregoing methods may be adopted. In another way, for a mode of classifying different priority classes according to different service types, a certain priority class includes a service type.

The present embodiment describes, with uplink, but not limited to the uplink, that different priority classes determine different element values in different LBT mechanisms or LBT mechanism parameter sets or parameter sets in a certain LBT mechanism. The method may also be applied to downlink.

The first type corresponds to different LBT mechanism parameter sets according to the priority classes of channels and/or signals and/or logical channels or combinations thereof.

Several typical priority classification modes will be given below, but the priority classes are not limited to the priority classes and order given in the present embodiment, instead they may be all possible combinations and classes, and are not limited to only four different priority classes.

Case 1: PUCCH, PUSCH, SRS, and PRACH exist at the same time, and have different priority classes, and the case of being classified into four priority classes may be one of the following:

PUCCH (priority class 1 (highest priority class))>PRACH>PUSCH>SRS (priority class 4 (lowest priority class)); or, PUCCH>PRACH>SRS>PUSCH; or, PUCCH>PUSCH>SRS>PRACH; Or, PUCCH>PUSCH>PRACH>SRS; or, PUCCH>SRS>PUSCH>PRACH; or, PUCCH>SRS>PRACH>PUSCH; or, PRACH>PUCCH>PUSCH>SRS; or, PRACH>PUCCH>SRS>PUSCH, or, PRACH>PUSCH>PUCCH>SRS; or, PRACH>PUSCH>SRS>PUCCH, or, PRACH>SRS>PUSCH>PUCCH; or, PRACH>SRS>PUCCH>PUSCH, or, PUSCH>PUCCH>PRACH>SRS; or, PUSCH>PUCCH>SRS>PRACH, or, PUSCH>PRACH>SRS>PUCCH; or, PUSCH>PRACH>PUCCH>SRS, or, PUSCH>SRS>PUCCH>PRACH; or, PUSCH>SRS>PRACH>PUCCH, or, SRS>PUCCH>PRACH>PUSCH; or, SRS>PUCCH>PUSCH>PRACH; or, SRS>PRACH>PUSCH>PUCCH; or, SRS>PRACH>PUCCH>PUSCH, or, SRS>PUSCH>PRACH>PUCCH, or, SRS>PUSCH>PUCCH>PRACH.

Case 2: PUCCH, PUSCH, SRS, and PRACH exist at the same time, and their priority classes are partially different or partially the same, or totally the same. Herein, only some of the same or different examples are used to describe that there may be multiple signals and/or logical channels in the same priority class, where the case of being classified into three priority classes may be one of the following:

PUCCH, PUSCH (priority class 1 (highest priority class))>PRACH>SRS (priority class 3 (lowest priority class)); or, PUCCH, PUSCH>SRS>PRACH; or, SRS>PUCCH, PUSCH>PRACH; or, SRS>PRACH>PUCCH, PUSCH; or, PRACH>SRS>PUCCH, PUSCH; or, PRACH>PUCCH, PUSCH>SRS, and the like, wherein signals and/or logical channels in the same priority class use the same LBT mechanism and/or LBT mechanism parameter set or parameter set element configuration quantity under a certain LBT mechanism when performing channel contention-based access. In addition, according to different requirements, the number of priority classes that may be classified is different, and the number of signals and/or logical channels included in a certain priority class may be different. That is to say, as long as the signals and/or logical channel are within a certain priority class, an LBT mechanism and/or LBT mechanism parameter set corresponding to a priority class and/or a parameter configuration value under a certain LBT mechanism will be adopted during channel contention-based access.

Preferably, it is assumed that the descending order of the priority classes of the logical channels is as follows: a C-RNTI or data from a UL-CCCH having a highest priority class; a Media Access Control (MAC) unit for a BSR and a BSR not including Padding; an MAC control unit for a PHR or an extended PHR; data in any logical channel but out of data in a UL-CCC; and a BSR of which the lowest priority class is Padding. If the UL-CCCH carrying the C-RNTI or data is mapped onto a UL-SCH, since a logical channel CCCH has the highest priority class when carrying the C-RNTI or the data, after mapping to the UL-SCH, an uplink shared channel has a relatively high priority class of transmission. Others adopt the same way.

It is important to note that the channels, the signals and the logical signals may have different priority classes independently from each other, so that they have different LBT mechanisms or different LBT mechanism parameter sets corresponding to different priority classes or different parameter configuration quantities of parameter sets under a certain LBT mechanism. The channels, the signals and the logical signals are combined with each other to have different LBT mechanisms or different LBT mechanism parameter sets corresponding to different priority classes or different element configuration values of parameter sets under a certain LBT mechanism.

The second type is different LBT mechanisms or LBT mechanism parameter sets corresponding to different service type priority classes.

A current protocol stipulates that an LTE system has 13 priority classes, which may be divided into four categories according to service types: Voice, Video, Signaling, and Real Time Gaming. That is, four different priority classes may be assigned according to four service types, wherein a priority class corresponding to a certain service type may include multiple services of the same type. A certain service type also corresponds to an LBT mechanism or LBT mechanism parameter set or a parameter set under a certain LBT mechanism. For example, service types corresponding to different priority classes are only examples here, but the order of priority classes corresponding to each service type is not limited thereto. See Table 1:

TABLE 1

| Priority class | Service type |
|---|---|
| 1 | Signaling |
| 2 | Voice |
| 3 | Video |
| 4 | Real Time Gaming |

Alternatively, it may be divided into several priority classes according to the priority class order in the LTE system specified in the existing protocol. Or, several priority classes are determined according to a data packet delay and a packet loss rate. Or, several priority classes are determined according to a relatively high priority class combination of GBR and Non-GBR resource types. For example, a priority class 1 corresponds to QCI 1/5/66, and a priority class 2 corresponds to QCI 2/3/6, wherein several priority classes may be obtained in a predefined mode, or, a service type-based mode, or a base station configuration mode. The number of priority classes is preferably 4 classes, alternatively, greater than or equal to 2, smaller than class 13, or otherwise.

In the subordinate embodiments, different LBT mechanism parameter sets may be determined according to one of the solutions provided in the first embodiment.

### Second Embodiment

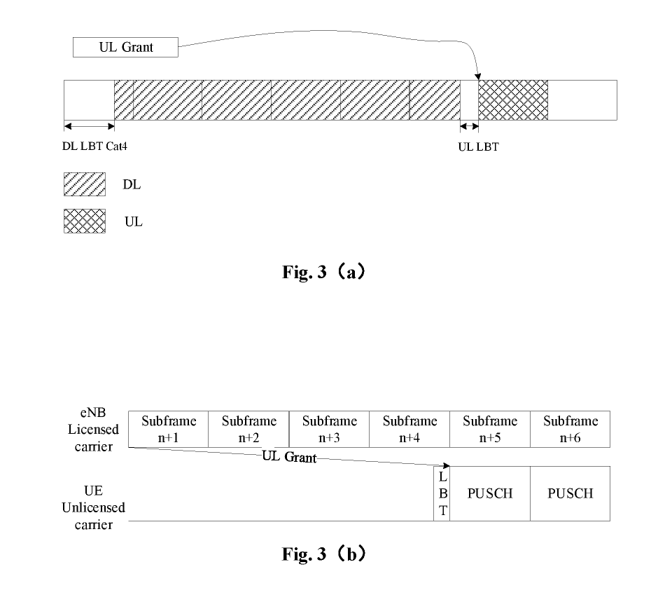

The embodiment focuses on elaborating priority classes corresponding to different channels and/or different signals and/or different logical channels, and adopts different parameter sets corresponding to an LBT Cat2 mechanism during channel contention-based access, wherein FIG. 3(a) is a schematic diagram illustrating that an LAA UE executes LBT under a self-scheduling mode according to the disclosure; and FIG. 3(b) is a schematic diagram illustrating that an LAA UE executes LBT under a cross-carrier scheduling mode according to the disclosure.

Specifically, in the present embodiment, different priority classes correspond to different parameter sets in an LBT Cat2 mechanism. Here, elements in the parameter sets are CCA durations. Different parameter sets refer to different CCA durations. For example, the CCA durations are 34 us, 25 us, 20 us, 18 us, 16 us, 9 us, and 4 us. As the priority classes are higher, the CCA durations in the corresponding LBT Cat2 mechanism are shortened sequentially. For example, see Table 2 below:

TABLE 2

| Priority class | CCA duration |
|---|---|
| 1 | A |
| 2 | B |
| 3 | C |
| 4 | D |

In Table 2, the priority classes in the present embodiment are priority classes corresponding to different channels and/or different signals and/or different logical channels. The priority class 1 is the highest priority class, and the priority classes descend sequentially. In the present embodiment, for example, the priority class 4 is the lowest priority class, but the priority class is not limited to these 4 classes. Further, each priority class may contain at least one channel and/or signal and/or logical channel. The values of A, B, C, and D are sequentially increased, that is, A<B<C<D.

The following will illustrate the appropriate value of a CCA duration when channels and/or signals and/or logical channels within different priority classes adopt an LBT Cat2 mechanism for channel access.

### Example 1

a PUCCH corresponds to a priority class 1, a PUSCH corresponds to a priority class 2, an SRS corresponds to a priority class 3, and a PRACH corresponds to a priority class 4. The CCA durations corresponding to different priority classes are shown in Table 3-1.

TABLE 3-1

| Priority class | Type | CCA duration |
|---|---|---|
| 1 | PUCCH | A may be 9 us/4 us |
| 2 | PUSCH | B may be 16 us/18 us |
| 3 | SRS | C may be 20 us |
| 4 | PRACH | D may be 25 us or |
| | | above |

### Example 2

a PUCCH and a PUSCH correspond to a priority class 1, an SRS corresponds to a priority class 2, a PRACH corresponds to a priority class 3, and a CCCH, a DCCH and a DTCH correspond to a priority class 4. The CCA durations corresponding to different priority classes are shown in Table 3-2.

TABLE 3-2

| Priority class | Type | CCA duration |
|---|---|---|
| 1 | PUCCH, PUSCH | A may be 16 us |
| 2 | SRS | B may be 20 us |
| 3 | PRACH | C may be 25 us |
| 4 | CCCH, DCCH, DTCH | D may be 34 us |

### Example 3

For example, only when there are logical channels, after the priority classes of different logical channels are mapped onto a physical shared channel, the corresponding mapped physical shared channel also has a certain priority class. Preferably, when the physical shared channel with a certain priority class needs to be sent during channel access, a CCA time of an LBT Cat2 mechanism corresponding to a priority class is adopted as shown in Table 4.

TABLE 4

| Priority class | Type | CCA duration |
|---|---|---|
| 1 | PUSCH onto which | A may be 16 us |
| | UL-CCCH carrying | |
| | C-RNTI or data is | |
| | mapped | |
| 2 | PUSCH onto which | B may be 20 us |
| | BSR and BSR not | |
| | containing Padding are | |
| | mapped | |
| 3 | PUSCH onto which | C may be 25 us |
| | data in any logical | |
| | channel but out of data | |
| | from UL-CCC is | |
| | mapped | |
| 4 | PUSCH onto which | D may be 34 us |
| | BSR containing | |
| | Padding is mapped | |

Herein, the order of descending priority classes of the logical channels specified in the LTE system is as follows: a C-RNTI or data from a UL-CCCH having a highest priority class; an MAC unit for a BSR and a BSR not including Padding; an MAC control unit for a PHR or an extended PHR; data in any logical channel but out of data in a UL-CCC, and a BSR of which the lowest priority class is Padding. If the UL-CCCH carrying the C-RNTI or data is mapped onto a UL-SCH, since a logical channel CCCH has the highest priority class when carrying the C-RNTI or the data, after mapping to the UL-SCH, an uplink shared channel has a relatively high priority class of transmission.

If different priority classes correspond to different parameter sets in an enhanced LBT Cat2 mechanism, the principle is the same as described above for LBT Cat2, wherein the enhanced version of LBT Cat2 is the process of performing multiple CCAs. That is, if CCA detects that the channel is busy, CCA continues. As long as the continuous detection channel idle time meets a configured CCA duration, it is considered that a UE successfully obtains a right of using an unlicensed carrier. In addition, the CCA start position may be flexibly configured within an available LBT detection time period, or may be configured as a fixed position.

Preferably, corresponding to different scheduling mechanisms such as a self-scheduling mechanism and a cross-carrier scheduling mechanism, the same CCA duration may be used for the same priority class. Different CCA durations may also be used. Alternatively, the CCA duration corresponding to the cross-carrier scheduling mechanism is longer than that of the self-carrier scheduling mechanism. The following example illustrates:

TABLE 5

| | | CCA duration during |
|---|---|---|
| | CCA duration during | cross-carrier |
| Priority class | self-scheduling | scheduling |
| 1 | A is 9 us | A is 9 us |
| 2 | B is 16 us | B is 16 us |
| 3 | C is 20 us | C is 20 us |
| 4 | D is 25 us | D is 25 us |

TABLE 6

| | | CCA duration during |
|---|---|---|
| Priority | CCA duration during | cross-carrier |
| class | self-scheduling | scheduling |
| 1 | A is 9 us | X is 16 us |
| 2 | B is 16 us | Y is 20 us |
| 3 | C is 20 us | Z is 25 us |
| 4 | D is 25 us | Q is 34 us |

Herein, Table 5 shows that self-scheduling and cross-carrier scheduling use the same LBT Cat2 parameter configuration, and Table 6 shows that self-scheduling and cross-carrier scheduling use different LBT Cat2 parameter configurations, that is, the values of X, Y, Z and Q in the case of cross-carrier scheduling may be different from the values of A, B, C, and D in the case of self-scheduling. Preferably, for the self-scheduling mode in Table 6, when the priority class of a certain channel and/or signal (in the present embodiment, a certain channel and/or signal is PUCCH) is 1, an LBT Cat2 mechanism is correspondingly executed during channel contention-based access, and a CCA duration is 9 us. If for cross-carrier scheduling, a channel or signal or logical channel in the same priority class executes an LBT Cat2 mechanism during channel contention-based access, a CCA duration is 16 us, and X<Y<Z<Q.

Different LBT Cat2 parameters are corresponded according to the order of priority classes. Note: different channels and/or different signals and/or different logical channels within the same priority class correspond to the same LBT Cat2 parameter configuration, but different LBT parameter configurations correspond to priority classes.

It should be noted that the class corresponding to each priority class is not limited to the class or parameter given in the present embodiment.

Preferably, which specific channels and/or signal and/or logical channels are included in each class may be determined according to requirements or predefined or upper-layer configuration or base station indication.

In special cases, if different channels and/or signals do not distinguish LBT mechanisms or parameter configurations during channel contention-based access, that is, regardless of which channel and/or signal uses the same LBT mechanism or parameter, LBT parameters are set according to the lowest class. For example, a CCA duration in an LBT Cat2 mechanism is D or Q for the channel contention-based access, and the duration is 25 us or 34 us. Alternatively, LBT parameters or mechanisms adopted by each channel and/or signal during channel contention-based access may be set according to the highest priority class, so that the channel and/or signal and/or logical channel have high priority class, and therefore high channel access opportunities may be provided to successfully preempt unlicensed carriers. Alternatively, channels and/or signals that are not successfully contended may send their own channels and/or signals on an unlicensed carrier that is successfully preempted by channels and/or signals that belong to the same UE or different UEs in the same operator or the same cell.

At least one of the number of priority classes involved in the present embodiment, the class corresponding to the priority class and the LBT parameter configuration corresponding to the priority class (e.g., A, B, C, D, or X, Y, Z, Q) may be notified of the change of corresponding information by a predefined mode, or a base station indication mode, or an upper-layer signaling mode, or a specific indication mode.

### Third Embodiment

The embodiment focuses on elaborating priority classes corresponding to different channels service types, and adopts different parameter sets corresponding to an LBT Cat2 mechanism during channel contention-based access.

Specifically, in the present embodiment, different priority classes correspond to different parameter sets in an LBT Cat2 mechanism. Here, elements in the parameter sets are CCA durations. Different parameter sets refer to different CCA durations. For example, the CCA durations are 34 us, 25 us, 20 us, 18 us, 16 us, 9 us, and 4 us. As the priority classes are higher, the CCA durations in the corresponding LBT Cat2 mechanism are shortened sequentially. For example, see Table 7 below:

TABLE 7

| Priority class | CCA duration |
|---|---|
| 1 | A |
| 2 | B |
| 3 | C |
| 4 | D |

In Table 7, the priority classes in the present embodiment are priority classes corresponding to different service types. The priority class 1 is the highest priority class, and the priority classes descend sequentially. In the present embodiment, for example, the priority class 4 is the lowest priority class, but the priority class is not limited to these 4 classes. Further, each priority class may contain at least one channel and/or signal and/or logical channel. The values of A, B, C, and D are sequentially increased, that is, A<B<C<D. Here, only the situation in which different service types are divided into 4 priority classes is taken as an example, wherein the service types are: Signaling, Voice, Video, and Real Time Gaming. It is assumed here that the service type Signaling corresponds to the highest priority class, the service type Voice corresponds to the second highest priority class, and so on, and the corresponding priority classes are decreased sequentially. The appropriate value of a CCA duration when different service types should adopt an LBT Cat2 mechanism at corresponding priority classes may be as shown in Table 8:

TABLE 8

| Priority class | Service type | CCA duration |
|---|---|---|
| 1 | Signaling | A may be 9 us |
| 2 | Voice | B may be 16 us |
| 3 | Video | C may be 20 us |
| 4 | Real Time Gaming | D may be 25 us |

Preferably, corresponding to different scheduling mechanisms such as a self-scheduling mechanism and a cross-carrier scheduling mechanism, the same CCA duration may be used for the same priority class. Different CCA durations may also be used. Alternatively, the CCA duration corresponding to the cross-carrier scheduling mechanism is longer than that of the self-carrier scheduling mechanism. The following example illustrates:

TABLE 9

| | | CCA duration during |
|---|---|---|
| Priority | CCA duration during | cross-carrier |
| class | self-scheduling | scheduling |
| 1 | A is 9 us | A is 9 us |
| 2 | B is 16 us | B is 16 us |
| 3 | C is 20 us | C is 20 us |
| 4 | D is 25 us | D is 25 us |

TABLE 10

| | | CCA duration during |
|---|---|---|
| Priority | CCA duration during | cross-carrier |
| class | self-scheduling | scheduling |
| 1 | A is 9 us | X is 16 us |
| 2 | B is 16 us | Y is 20 us |
| 3 | C is 20 us | Z is 25 us |
| 4 | D is 25 us | Q is 34 us |

Herein, Table 9 shows that self-scheduling and cross-carrier scheduling use the same LBT Cat2 parameter configuration, and Table 10 shows that self-scheduling and cross-carrier scheduling use different LBT Cat2 parameter configurations, that is, the values of X, Y, Z and Q in the case of cross-carrier scheduling may be different from the values of A, B, C, and D in the case of self-scheduling. Preferably, for the self-scheduling mode in Table 6, when the priority class of a certain service type (in the present embodiment, a certain service type is Signaling) is 1, an LBT Cat2 mechanism is correspondingly executed during channel contention-based access, and a CCA duration is 9 us. If for cross-carrier scheduling, a service type in the same priority class executes an LBT Cat2 mechanism during channel contention-based access, a CCA duration is 16 us, and X<Y<Z<Q.

Different LBT Cat2 parameters are corresponded according to the order of priority classes. Note: service types within the same priority class correspond to the same LBT Cat2 parameter configuration, but different LBT parameter configurations correspond to priority classes (or different service types).

In special cases, if different QoS priority classes (priority classes corresponding to different service types) do not distinguish LBT mechanisms or parameter configurations during channel contention-based access, that is, regardless of which QoS priority class uses the same LBT mechanism or parameter, LBT parameters are set according to the lowest class. For example, a CCA duration in an LBT Cat2 mechanism is D or Q for the channel contention-based access, and the duration is 25 us or 34 us. Or, an LBT Cat2 parameter corresponding to the highest priority class may also be adopted for the channel contention-based access.

A defer period in an LBT Cat4 mechanism in the following embodiments is composed of 16 us+n*slot, or n*slot+16 us, wherein for uplink, n in the defer period may be within [0, 2]. For downlink, n in the defer period may be within [1, 7]. A slot length in the composition of defer period is 9 us.

### Fourth Embodiment

The present embodiment is directed to the priority classes of different channels and/or different signals and/or different logical channels. An LAA device correspondingly adopts an LBT Cat4 mechanism or different parameter sets in LBT Cat4 for detailed description during channel contention-based access.

If uplink adopts the LBT Cat4 mechanism for contention-based access to an unlicensed carrier, parameters related to LBT Cat4 include CCA (e.g., initial CCA), a random backoff value N, a minimum contention window CWmin, a maximum contention window CWmax, a defer period (16 us+n*one-time random backoff CCA duration (e.g., 9 us) or, n*slot+16 us), wherein an initial CCA duration may be configured as 9 us (one-time random backoff CCA time slot length in ECCA), or, 25 us (e.g., 9 us+16 us, 9 us for channel detection), or, 34 us (9 us+(16 us+9 us)), or, 20 us, or 16 us, or 18 us. The value of n in the defer period may be within [0, 2]. Specifically, in the present embodiment, different LBT Cat4 mechanism parameter sets are correspondingly adopted in channel contention-based access according to different priority classes of channels and/or signals and/or logical channels. Here, the corresponding LBT Cat4 mechanism parameter sets at different priority classes are still described by using PUCCH, PUSCH, SRS, and PRACH as examples. Only one possible situation is represented, and other signals and/or channels may also use a method of correspondence between a priority class and an LBT Cat4 parameter described below.

The following will illustrate, according to different priority classes of channels and/or signals and/or logical channels, different LBT Cat4 mechanism parameter sets adopted correspondingly during channel contention-based access.

### Example 1

When the maximum contention window has a maximum value of 3 and the fixed value of n is 1, different priority classes correspond to parameter configurations in LBT Cat4.

TABLE 11

| Priority class | CWmin | CWmax | n |
|---|---|---|---|
| 1 | 0 | 1 | 1 |
| 2 | 1 | 2 | 1 |
| 3 | 2 | 2.5 | 1 |
| 4 | 2.5 | 3 | 1 |

### Example 2

When the maximum contention window has a maximum value of 3 and n corresponding to different priority classes may be different, different priority classes correspond to parameter configurations in LBT Cat4.

TABLE 12

| Priority class | CWmin | CWmax | n |
|---|---|---|---|
| 1 | 0 | 1 | 0 |
| 2 | 1 | 2 | 0 |
| 3 | 2 | 2.5 | 1 |
| 4 | 2.5 | 3 | 1 |

### Example 3

When the maximum contention window has a maximum value of 4 and the fixed value of n is 1, different priority classes correspond to parameter configurations in LBT Cat4.

TABLE 13

| Priority class | CWmin | CWmax | n |
|---|---|---|---|
| 1 | 1 | 2 | 1 |
| 2 | 2 | 3 | 1 |
| 3 | 2.5 | 3.5 | 1 |
| 4 | 3 | 4 | 1 |

### Example 4

When the maximum contention window has a maximum value of 5 and the fixed value of n is 1, different priority classes correspond to parameter configurations in LBT Cat4.

TABLE 14

| Priority class | CWmin | CWmax | n |
|---|---|---|---|
| 1 | 1 | 2 | 1 |
| 2 | 2 | 3 | 1 |
| 3 | 3 | 4 | 1 |
| 4 | 4 | 5 | 1 |

### Example 5

When the maximum contention window has a maximum value of 6 and the fixed value of n is 1, different priority classes correspond to parameter configurations in LBT Cat4.

TABLE 15-1

| Priority class | CWmin | CWmax | n |
|---|---|---|---|
| 1 | 1 | 3 | 1 |
| 2 | 2 | 4 | 1 |
| 3 | 4 | 5 | 1 |
| 4 | 5 | 6 | 1 |

### Example 6

When the maximum contention window has a maximum value of 7 and the fixed value of n is 1, different priority classes correspond to parameter configurations in LBT Cat4.

TABLE 15-2

| Priority class | CWmin | CWmax | n |
|---|---|---|---|
| 1 | 1 | 3 | 1 |
| 2 | 3 | 5 | 1 |
| 3 | 5 | 6 | 1 |
| 4 | 5 | 7 | 1 |

### Example 7

When the maximum contention window has a maximum value of 13 and the fixed value of n is 1, different priority classes correspond to parameter configurations in LBT Cat4.

TABLE 16-1

| Priority class | CWmin | CWmax | n |
|---|---|---|---|
| 1 | 1 | 3 | 1 |
| 2 | 3 | 5 | 1 |
| 3 | 5 | 7 | 1 |
| 4 | 8 | 13 | 1 |

### Example 8

When the maximum contention window has a maximum value of 15 and the fixed value of n is 1, different priority classes correspond to parameter configurations in LBT Cat4.

TABLE 16-2

| Priority class | CWmin | CWmax | n |
|---|---|---|---|
| 1 | 1 | 3 | 1 |
| 2 | 3 | 5 | 1 |
| 3 | 5 | 7 | 1 |
| 4 | 7 | 15 | 1 |

The above table is only a part of the embodiments, wherein according to different priority classes corresponding to channels and/or signals and/or logical channels, a corresponding LBT Cat4 mechanism parameter set configuration may be selected during channel contention-based access. The parameter set here is configured as: a minimum contention window CWmin, a maximum contention window CWmax, and n, wherein different priority classes correspond to different parameter combination configuration values. That is, the parameter set values between different priority classes are different, and the range of the maximum contention window is also different. As the priority classes are decreased sequentially, the corresponding contention windows are increased sequentially, and n may be configured with the same value for different priority classes, and may also be configured with different values.

Preferably, the same LBT Cat4 mechanism parameter set may be adopted for the self-scheduling mode and the cross-carrier scheduling mode, that is, the same LBT Cat4 mechanism parameter set is adopted for both scheduling mechanisms of a certain priority class. LBT Cat4 mechanism parameter sets between different priority classes are different.

Or, two scheduling mechanisms may also use different LBT Cat4 mechanism parameter sets, that is, for a certain priority class, the two scheduling mechanisms use different LBT Cat4 mechanism parameter sets during channel contention-based access. The following will take detailed examples to illustrate which LBT Cat4 mechanism parameter set configurations correspond to specific different priority classes.

First case: For self-scheduling and cross-carrier scheduling mechanisms, the same LBT Cat4 mechanism parameter set is adopted for the two scheduling mechanisms at a certain priority class. See Table 17 for details.

TABLE 17

| | | | | Cross-carrier | | n | |
|---|---|---|---|---|---|---|---|
| Priority | | Self-scheduling | | scheduling | | Self- | Cross-carrier |
| class | Type | CWmin | CWmax | CWmin | CWmax | scheduling | scheduling |
| 1 | PUCCH | a1 | a2 | a1 | a2 | 1 | 1 |
| 2 | PUSCH | a3 | a4 | a3 | a4 | 1 | 1 |
| 3 | SRS | a5 | a6 | a5 | a6 | 1 | 1 |
| 4 | PRACH | a7 | a8 | a7 | a8 | 1 | 1 |

As can be seen from Table 17, regardless of which priority class and/or scheduling mechanism, the value of n in a composition of a defer period is 1. For a certain priority class, it can be seen from Table 17 that different scheduling mechanisms correspond to the same maximum contention window CWmax and minimum contention window CWmin and n values for a certain priority class. The ranges of values for a1 and a2, a3 and a4, a5 and a6, a7 and a8 may partially overlap or may not overlap. In addition, if the uplink also uses an LBT Cat4 mechanism, it is as much as possible to select a contention window smaller than LBT Cat4 used in the downlink. Here, the minimum value of CWmin may be 1, 3, 5, 7, 15, and so on. The maximum value of CWmax is less than 1023. For example, the maximum values are 511, 255, 127, 63, 31, 15, 7, 6, 5, 4, 3, 2, and so on.

Preferably, for example, different channel and/or signal and/or logical channel priority classes correspond to different LBT Cat4 mechanism parameter sets.

For a priority class 1 (highest priority class), such as a PUCCH, during channel contention-based access, an LBT Cat4 mechanism is executed. A corresponding minimum contention window CWmin may be configured as a1. For example, CWmin is 1. A maximum contention window CWmax may be configured as a2. For example, CWmax is 3.

For a priority class 2, such as a PUSCH, during channel contention-based access, an LBT Cat4 mechanism is executed. A corresponding minimum contention window CWmin may be configured as a3. For example, CWmin is 2. A maximum contention window CWmax may be configured as a4. For example, CWmax=3.

For a priority class 3, such as an SRS, during channel contention-based access, an LBT Cat4 mechanism is executed. A corresponding minimum contention window CWmin may be configured as a5. For example, CWmin is 4. A maximum contention window CWmax may be configured as a6. For example, CWmax is 5.

For a priority class 4 (lowest priority class in the present embodiment), such as a PRACH, during channel contention-based access, an LBT Cat4 mechanism is executed. A corresponding minimum contention window CWmin may be configured as a7. For example, CWmin is 6. A maximum contention window CWmax may be configured as a8. For example, CWmax is 7.

Herein, there may be k priority classes, and the specific number may be pre-defined, or may be determined according to channels and/or signals, or may be determined according to different combinations of LBT parameter contention windows and/or n values, and the like. The above content has 4 priority classes, which correspond to different LBT Cat4 mechanism parameter set configurations respectively.

As another example, different channel and/or signal and/or logical channel priority classes correspond to different LBT Cat4 mechanism parameter sets.

For a priority class 1 (highest priority class), such as a PUCCH, during channel contention-based access, an LBT Cat4 mechanism is executed. A corresponding minimum contention window CWmin may be configured as a1. For example, CWmin is 1. A maximum contention window CWmax may be configured as a2. For example, CWmax is 3.

For a priority class 2, such as a PUSCH, during channel contention-based access, an LBT Cat4 mechanism is executed. A corresponding minimum contention window CWmin may be configured as a3. For example, CWmin is 4. A maximum contention window CWmax may be configured as a4. For example, CWmax=7.

For a priority class 3, such as an SRS, during channel contention-based access, an LBT Cat4 mechanism is executed. A corresponding minimum contention window CWmin may be configured as a5. For example, CWmin is 8. A maximum contention window CWmax may be configured as a6. For example, CWmax is 10.

For a priority class 4 (lowest priority class in the present embodiment), such as a PRACH, during channel contention-based access, an LBT Cat4 mechanism is executed. A corresponding minimum contention window CWmin may be configured as a7. For example, CWmin is 11. A maximum contention window CWmax may be configured as a8. For example, CWmax is 14.

Second case: For self-scheduling and cross-carrier scheduling mechanisms, different LBT Cat4 mechanism parameter sets are adopted for the two scheduling mechanisms at a certain priority class.

According to the self-scheduling mode, before an eNB sends uplink grant information on an unlicensed carrier, the eNB should use a downlink LBT Cat4 mechanism to perform channel contention-based access to acquire a right of using the unlicensed carrier. A UE also needs to perform an uplink LBT process once before transmitting on a subframe on an unlicensed carrier scheduled by a base station. For the self-scheduled case, only when the two LBT processes are successfully executed, the UE can perform transmission on the scheduled subframe. For a Wi-Fi system, only one LBT process needs to be performed before information sending. In this way, an LAA needs to perform two LBT processes before uplink transmission, thus being in an unfavorable contention-based access position, which affects the contention-based access opportunity of a channel to some extent. Therefore, for the self-scheduling case, if the UE needs to adopt the LBT Cat4 mechanism for contention-based access before transmission, it is necessary to configure a smaller contention window as much as possible, for example, compared to the contention window adopted by the LBT Cat4 mechanism used for cross-carrier scheduling, the contention window value is smaller. Preferably, in the cross-carrier scheduling mode, the contention window smaller than the contention window used by downlink LBT Cat4 is selected.

According to the above content, different priority classes correspond to different LBT Cat4 parameters in the self-scheduling and cross-carrier scheduling modes. See Table 18 for details.

TABLE 18

| | | | | Cross-carrier | | n | |
|---|---|---|---|---|---|---|---|
| Priority | | Self-scheduling | | scheduling | | Self- | Cross-carrier |
| class | Type | CWmin | CWmax | CWmin | CWmax | scheduling | scheduling |
| 1 | PUCCH | a1 | a2 | X1 | X2 | 1 | 1 |
| 2 | PUSCH | a3 | a4 | X3 | X4 | 1 | 1 |
| 3 | SRS | a5 | a6 | X5 | X6 | 1 | 1 |
| 4 | PRACH | a7 | a8 | X7 | X8 | 1 | 1 |

Here, n in a composition of a defer period is set to 1. For a certain priority class, it can be seen from Table 18 that different scheduling mechanisms correspond to different maximum contention windows CWmax and minimum contention windows CWmin for a certain priority class. The ranges of values for a1 and a2, a3 and a4, a5 and a6, a7 and a8 may or may not overlap. Similarly, the ranges of values for X1 and X2, X3 and X4, X5 and X6, X7 and X8 may partially overlap or may not overlap. The minimum value of CWmin may be 1, 3, 5, 7, 15, and so on. The maximum value of CWmax is less than 1023. For example, the maximum values are 511, 255, 127, 63, 31, 15, 7, 6, 5, 4, 3, 2, and so on.

For example, under the same priority class, different scheduling modes correspond to correspondences and principles of different LBT Cat4 mechanism parameter sets respectively, and the numerical settings in the table are not limited to the settings in the table:

TABLE 19

| | | | | Cross-carrier | | n | |
|---|---|---|---|---|---|---|---|
| Priority | | Self-scheduling | | scheduling | | Self- | Cross-carrier |
| class | Type | CWmin | CWmax | CWmin | CWmax | scheduling | scheduling |
| 1 | PUCCH | 1 | 2 | 1 | 3 | 1 | 1 |
| 2 | PUSCH | 2 | 3 | 3 | 4 | 1 | 1 |
| 3 | SRS | 4 | 5 | 5 | 6 | 1 | 1 |
| 4 | PRACH | 5 | 6 | 6 | 7 | 1 | 1 |

Another example shows that under the same priority class, different scheduling modes correspond to correspondences and principles of different LBT Cat4 mechanism parameter sets respectively, as shown in Table 20:

TABLE 20

| | | | | Cross-carrier | | n | |
|---|---|---|---|---|---|---|---|
| Priority | | Self-scheduling | | scheduling | | Self- | Cross-carrier |
| class | Type | CWmin | CWmax | CWmin | CWmax | scheduling | scheduling |
| 1 | PUCCH | 1 | 2 | 1 | 3 | 1 | 1 |
| 2 | PUSCH | 2 | 5 | 3 | 6 | 1 | 1 |
| 3 | SRS | 5 | 7 | 6 | 9 | 1 | 1 |
| 4 | PRACH | 8 | 13 | 11 | 14 | 1 | 1 |

TABLE 21

| | | | | Cross-carrier | | n | |
|---|---|---|---|---|---|---|---|
| Priority | | Self-scheduling | | scheduling | | Self- | Cross-carrier |
| class | Type | CWmin | CWmax | CWmin | CWmax | scheduling | scheduling |
| 1 | PUCCH | 1 | 2 | 1 | 3 | 1 | 1 |
| 2 | PUSCH | 2 | 5 | 3 | 6 | 1 | 1 |
| 3 | SRS | 5 | 7 | 7 | 15 | 1 | 1 |
| 4 | PRACH | 7 | 15 | 15 | 31 | 1 | 1 |

Specifically, for each priority class in the first and/or second cases, parameter values in the corresponding LBT Cat4 mechanism parameter set are not limited to the exemplary values in the present embodiment. In addition, the value of n in a composition of a defer period may also be a flexible value within [0, 2]. It is not limited to using n as 1 for different priority classes. For example, for different priority classes, the value of n under the same scheduling mechanism may also be set to different values. Preferably, for the same priority class, n values corresponding to different scheduling mechanisms may also be set to different values.

### Fifth Embodiment

In the present embodiment, for different scheduling modes, according to priority classes corresponding to different service types, an LAA device correspondingly adopts an LBT Cat4 mechanism or different parameter sets in LBT Cat4 for detailed description during channel contention-based access.

Here, only the situation in which different service types are divided into 4 priority classes is taken as an example, wherein the service types are: Signaling, Voice, Video, and Real Time Gaming. It is assumed here that the service type Signaling corresponds to the highest priority class, the service type Voice corresponds to the second highest priority class, and so on, and the corresponding priority classes are decreased sequentially. Specifically, in the present embodiment, different LBT Cat4 mechanism parameter sets corresponding to different priority classes in the fourth embodiment may also be adopted for the priority classes of different service types. Preferably, for different priority classes corresponding to a certain service type, different scheduling mechanisms may use the same LBT Cat4 mechanism parameter set (e.g., a minimum contention window CWmin, a maximum contention window CWmax, and n in the composition of a defer period, alternatively, initial CCA is included). Similarly, different scheduling mechanisms may also use different LBT Cat4 mechanism parameter sets (e.g., corresponding parameter values are different).

In the first case of the fourth embodiment, for the priority class of a certain service type, the same LBT Cat4 mechanism parameter set is adopted for self-scheduling and cross-carrier scheduling mechanisms. For example, if the service type Signaling has the highest priority class, the contention window is the smallest window in the corresponding LBT Cat4 parameter, and n in the composition of the defer period may be an integer value within [0, 2]. In turn, the priority class of the service type Real Time Gaming is the lowest, and the corresponding LBT Cat4 has the maximum contention window.

Similarly, in the second case of the fourth embodiment, different LBT Cat4 mechanism parameter sets are adopted for two scheduling mechanisms namely self-scheduling and cross-carrier scheduling mechanisms for a certain priority class. For example, for the same service type Signaling (assuming that it has the highest priority class), under the self-scheduling mode, the maximum and minimum contention windows of the parameter set of the corresponding LBT Cat4 mechanism are [1, 2], then under cross-carrier scheduling mode, the maximum and minimum contention windows of the parameter set of the corresponding LBT Cat4 mechanism may be [1, 3]. As the priority classes corresponding to different services are decreased sequentially, the possible range of the maximum and minimum values of the corresponding LBT Cat4 contention window is also gradually increased. For example, when the lowest priority class corresponds to the service type Real Time Gaming, the maximum and minimum contention windows of LBT Cat4 are [5, 7] in the case of self-scheduling. In the case of cross-carrier scheduling, the maximum and minimum contention windows of LBT Cat4 are [7, 9].

Preferably, for n in the composition of the defer period, for different scheduling mechanisms and different service type priority classes, the n value may be the same or different.

The maximum contention window CWmax and the minimum contention window CWmin in the above-described LBT Cat4 mechanism are intended to acquire a random backoff value N used in a random backoff process of an ECCA, where q is an integer randomly generated from [CWmin, CWmax], and N is a number randomly generated from [0, q−1].

### Sixth Embodiment

The present embodiment mainly elaborates on the situation that different priority classes correspond to different LBT mechanisms and/or LBT mechanism parameter sets.

Specifically, in the present embodiment, different priority classes include: priority classes corresponding to priority classes of different channels and/or signals; and different QoS priority classes (e.g., priority classes classified according to service types).

Different LBT mechanisms include: an LBT Cat2 mechanism without random backoff; and an LBT Cat4 mechanism with random backoff. Preferably, different LBT Cat4 types correspond to different contention window sizes and different values of n in the composition of a defer period. Currently, for the downlink, a maximum contention window is 1023. For the uplink, since the current uplink transmissions are based on a pre-scheduling mode, in order to reduce the waste of allocated resources and uplink indication information, the uplink needs to use a smaller contention window than the downlink. For example, the alternative value of the maximum contention window is 511, 255, 127, 63, 31, 15, 7, 6, 5, 4, 3, 2, etc. The minimum value of the contention window is 1.

Similarly, according to the priority classes of different channels and/or different signals and/or different logical channels, when a channel/signal has the highest priority class, correspondingly, the most simplified LBT Cat2 mode may be used during channel contention-based access. Alternatively, when the priority class of a certain channel/signal is only next to the highest priority class, an enhanced LBT Cat2 mode may be used during channel contention-based access. If there is no enhanced LBT Cat2 mechanism in uplink available LBT mechanisms, alternatively, it may correspond to an LBT Cat4 mechanism, and the maximum contention window value and the minimum contention window value are equal (a minimum contention window value corresponding to LBT Cat4). At this time, LBT Cat4 is an LBT Cat3 mechanism.

Preferably, if there is no enhanced LBT Cat2 mechanism in uplink candidate LBT mechanisms and there is no LBT Cat3 mechanism, in addition, when the priority class of a certain channel/signal is next to the highest priority class, an LBT Cat4 mode with the minimum contention window may be adopted during channel contention-based access.

Preferably, when the priority class of a certain channel/signal is only next to the second highest priority class, an LBT Cat4 mode larger than the minimum contention window may be adopted during channel contention-based access.

By analogy, as the priority class of a channel/signal is decreased, a corresponding LBT Cat4 contention window is also gradually increased.

Similarly, corresponding to different QoS priority classes, different service types correspond to a certain priority class, and further, a specific priority class corresponds to different LBT mechanisms. The specific principle is the same as different signals and/or channel priority classes.

In another case, different priority classes only correspond to different LBT mechanisms (such as LBT Cat2, LBT Cat4 (e.g., configured with a relatively maximum contention window corresponding to the above-mentioned lowest priority class, or configured with a minimum contention window corresponding to the highest priority class) or fast LBT). Preferably, for the selected LBT mechanism, the size of a contention window is adjusted according to ACK/NACK fed back in each burst, or an interference measurement situation within a period of time, or different service types.

For example, different priority classes only correspond to different LBT mechanisms (when there are multiple LBT mechanisms), as follows:

TABLE 22

| Priority class | LBT mechanism |
|---|---|
| 1 | LBT Cat2 |
| 2 | Enhanced LBT Cat2 |
| 3 | LBT Cat3 |
| 4 | LBT Cat4 |

For example, different priority classes only correspond to different LBT mechanisms and/or parameter sets (when there are multiple LBT mechanisms), as follows:

TABLE 23

| Priority class | LBT mechanism |
|---|---|
| 1 | LBT Cat2 |
| 2 | Enhanced LBT Cat2 |
| 3 | LBT Cat4 (contention window |
| | [1, 3], n) |
| 4 | LBT Cat4 (contention window |
| | [3, 5], n) |

Preferably, if an LBT mechanism is determined according to a priority class, a parameter set under the LBT mechanism used for contention-based access (e.g., a minimum contention window, a maximum contention window, n, or a random backoff value N) may be further determined according to the size of a data packet to be transmitted, and/or a specific uplink subframe, and/or the number of symbols available for performing an LBT process.

### Seventh Embodiment

The present embodiment mainly describes a processing method when different priority classes exist at the same time within the same burst or transmission period in detail, and a problem about how to process under initial transmission and retransmission scenarios.

For a plurality of different priority classes within the same burst or transmission period, it may be handled as follows.

Mode 1: An LBT process is executed according to a channel/signal or service type corresponding to the lowest (or second lowest) priority class, wherein a high-priority class signal/channel or service type contention window is small, so a random backoff value N is also relatively small compared to others, thereby having a higher channel access opportunity, obtaining a right of using an unlicensed carrier, and further performing transmission. For example, the q value corresponding to the lowest (or second-lowest) priority class may be selected between [CWmin=5, CWmax=7], and the random regression value N may have a maximum value of 6. The q value corresponding to the highest priority class may be selected between [CWmin=1, CWmax=3], and the random backoff N may have a maximum value of 2. Obviously, the highest priority class service or signal/channel has a higher channel access opportunity. Similarly, if the maximum contention window for the uplink is 3, the sizes of the contention windows corresponding to different priority classes may also be refined within this range by using the same method.

Mode 2: A serial mode is adopted. That is, different priority classes coexist in the same burst in a time division manner, and the highest priority class corresponds to the first part of time-frequency resources in the burst. By analogy, the lowest priority class corresponds to the last part of the time-frequency resources in the burst. It is also possible to configure an LBT mechanism or LBT mechanism parameter set for channels/signals or service types (QoS classs) corresponding to all priority classes. Different priority classes correspond to execution of the contention-based access. The LBT mechanism or LBT mechanism parameter set corresponds to the lowest or highest channel/signal or QoS class, or corresponds to all scheduled logical channels or logical channels to be used or the lowest or highest priority class or QoS class of channels or signals.

Mode 3: A parallel mode is adopted.

That is, multiple contention-based access processes are performed in parallel. Each contention-based access process is performed according to an LBT mechanism parameter set, and this parameter set corresponds to a channel/signal or service type, wherein the CCA detects that a channel is idle or a random backoff value N first descends to 0, a right of using an unlicensed carrier is acquired, and corresponding information transmission is performed. If the random backoff detection continues to be performed and it is found that the channel is always busy, then the current N value may be frozen. Once the channel is detected to be idle again, CCA detection or N value decrement in an ECCA process is continued.

In addition, different frequency domain resources may also be allocated to each channel/signal or service type. Different priority classes correspond to execution of a channel access process on different frequency domain resources according to corresponding LBT mechanisms or parameter sets. If the LBT is successful, transmission may be performed on the corresponding frequency domain resource or the entire resource. Other channels/signals/service types that can be multiplexed may reuse secured resources by detecting frequency domain patterns or identifying indication information.

Another scenario is initial transmission and retransmission. The retransmission should have a higher priority class than the initial transmission and the corresponding LBT mechanism or LBT mechanism parameter set. If the initial transmission corresponds to LBT Cat4, when an initially transmitted data packet is not decoded correctly, the corresponding priority class (such as a smaller LBT Cat4 contention window or a more simplified LBT mechanism, intended to increase the channel access probability) should be increased during retransmission. Specifically, the class of access is increased by several classes, which can be determined based on an offset value. The default value is offset=1.

Preferably, if a certain signal or a signal or service type is continuously at the lowest priority class for multiple times within a period of time, it results in a state in which contention-based access is unsuccessful, so it is shown that the load may be too heavy, or the contention collision may be very high, and it is then necessary to adjust its priority class. Or, if it is continuously at the highest priority class for multiple times, the channel can always be preempted with a high advantage. In order to achieve fairness among different channels/signals or service types, the priority class needs to be adjusted, that is, the corresponding priority class is reduced properly.

### Eighth Embodiment

In the present embodiment, for different scheduling modes, according to the priority classes of different channels and/or different signals and/or different logical channels or different QoS classes, it is determined that an LAA device performs an LBT Cat3 mechanism to describe applied parameter configurations in detail.

The LBT Cat3 mechanism is a special case of an LBT Cat4 mechanism. That is, when a minimum contention window CWmin and a maximum contention window CWmax in the LBT Cat4 mechanism are equal, LBT Cat4 is simplified to a Cat3 fixed contention window.

Here, only one situation in which self-scheduling and cross-carrier scheduling uses different LBT Cat3 parameters is listed, and the value of n in a composition of a defer period may be other values smaller than 7 other than 1. The details are shown in Table 24.

TABLE 24

| | | | Cross-carrier | | n | |
|---|---|---|---|---|---|---|
| Priority | Self-scheduling | | scheduling | | Self- | Cross-carrier |
| class | CWmin | CWmax | CWmin | CWmax | scheduling | scheduling |
| 1 | 2 | 2 | 2 | 2 | 0 | 0 |
| 2 | 3 | 3 | 4 | 4 | 0/1 | 1 |
| 3 | 5 | 5 | 6 | 6 | 1 | 2 |
| 4 | 7 | 7 | 7/8 | 7/8 | 2 | 2 |

Similarly, the value of n in the defer period may also be fixed as 1. The LBT parameters under different priority classes may also determine the maximum CWmax value according to base station indication or a configured time domain resource that can be used to perform LBT, and corresponding LBT parameter values between different priority classes may be different. Alternatively, different LBT Cat3 parameter sets may be used for self-scheduling and cross-carrier scheduling for the same priority class.

The above-mentioned examples represent only one possible situation in the disclosure and do not represent all possible situations.

The technical solutions described in the embodiments of the disclosure may be arbitrarily combined without conflict.

In several embodiments provided by the disclosure, it will be appreciated that the disclosed method and smart device may be implemented in another manner. The device embodiment described above is only schematic. For example, division of the units is only division of logical functions, and there may be additional division manners during practical implementation. For example, multiple units or assemblies may be combined or integrated to another system, or some characteristics may be omitted or may be not executed. In addition, coupling or direct coupling or communication connection between displayed or discussed components may be indirect coupling or communication connection, implemented through some interfaces, of the devices or the units, and may be electrical and mechanical or adopt other forms.

The above-mentioned units described as separate parts may or may not be physically separated, and parts displayed as units may or may not be physical units, and namely may be located in the same place, or may also be distributed to multiple network units. Part or all of the units may be selected to achieve the purpose of the solutions of the present embodiment according to a practical requirement.

In addition, each function unit in each embodiment of the disclosure may be integrated into a second processing unit, each unit may also exist independently, and two or more than two units may also be integrated into a unit. The integrated unit may be implemented in a hardware form, and may also be implemented in form of hardware and software function unit.

The above is only the detailed description of the disclosure, but the scope of protection of the disclosure is not limited thereto. As will occur to those skilled in the art, the disclosure is susceptible to changes or replacements within the technical scope of the disclosure. These changes or replacements should fall within the scope of protection of the disclosure.

### INDUSTRIAL APPLICABILITY

As above, the method and apparatus for configuring contention-based access parameters of an LAA device according to some embodiments of the disclosure have the beneficial effects as follows. By virtue of the solution, problems that an LAA system does not distinguish LBT parameters with different priority classes in a large congestion environment, resulting in that the LAA system executes contention-based access to an unlicensed carrier by using LBT parameters corresponding to a high-priority QoS class and a contention-based access opportunity is low are solved. In addition, problems of waste of uplink allocation resources and grant indication information, low spectrum efficiency and the like are further addressed.

1. A method for configuring contention-based access parameters of a Licensed-Assisted Access (LAA) device, comprising:
determining, according to different priority classes, different Listen Before Talk (LBT) mechanisms or different LBT mechanism parameter sets corresponding to the different priority classes;
executing contention-based access to an unlicensed carrier by using the different LBT mechanisms or the different LBT mechanism parameter sets corresponding to the different priority classes; and
transmitting, when a right of using the unlicensed carrier is successfully gained based on a used LBT mechanism or a used LBT mechanism parameter set, data by utilizing the unlicensed carrier.

2. (canceled)

3. (canceled)

4. The method for configuring contention-based access parameters of an LAA device as claimed in claim 1, wherein the different LBT mechanisms comprise at least one of:
an LBT Cat2 mechanism or an enhanced LBT Cat2 mechanism;
an LBT Cat4 mechanism;
an LBT Cat3 mechanism.

5. (canceled)

6. (canceled)

7. (canceled)

8. (canceled)

9. The method for configuring contention-based access parameters of an LAA device as claimed in claim 1, wherein parameters of the LBT mechanism parameter set comprise at least one of: a first CCA duration, a defer period, a maximum contention window CWmax, a minimum contention window CWmin, and a random backoff value N, and n in a composition of a defer period.

10.-22. (canceled)

23. The method for configuring contention-based access parameters of an LAA device as claimed in claim 1, wherein when the contention-based access to the unlicensed carrier is executed unsuccessfully/successfully by using an LBT mechanism parameter set corresponding to a current priority class, the method further comprises:
selecting, when the contention-based access to the unlicensed carrier is executed unsuccessfully continuously for multiple times within a period of time, a priority class higher than that of the LBT mechanism or LBT mechanism parameter set used in the unsuccessfully executed contention-based access; or,
selecting, when the contention-based access to the unlicensed carrier is executed successfully continuously for multiple times within a period of time, a priority class lower than that of the LBT mechanism or LBT mechanism parameter set used in the successfully executed contention-based access; or,
selecting for a next contention-based access an LBT mechanism or LBT mechanism parameter set corresponding to a priority class higher/lower than that of the LBT mechanism or LBT mechanism parameter set used in the unsuccessfully/successfully executed contention-based access; or,
when contention-based access to a channel according to an LBT mechanism or LBT mechanism parameter set is executed unsuccessfully for a first preset threshold number of times, selecting for the contention-based access to the channel an LBT mechanism parameter set with a smaller contention window and/or a shorter CCA duration or a simpler or faster LBT mechanism; or,
when contention-based access to a channel according to an LBT mechanism or LBT mechanism parameter set is executed successfully for a second preset threshold number of times, selecting for the contention-based access to the channel an LBT mechanism parameter set with a larger contention window and/or a longer CCA duration or an LBT mechanism with a more complicated process; or,
increasing or decreasing a priority class according to a measured interference variable.

24. The method for configuring contention-based access parameters of an LAA device as claimed in claim 1, further comprising:
when a plurality of different priority classes are present in one transmission burst or one transmission period or one subframe,
contending for the right of using the unlicensed carrier by executing an LBT mechanism according to an LBT parameter corresponding to the highest priority class; or,
contending for the right of using the unlicensed carrier by executing an LBT mechanism according to LBT parameters corresponding to different priority classes respectively; or,
contending for the right of using the unlicensed carrier by executing an LBT mechanism according to an LBT parameter corresponding to the lowest or second lowest priority class.

25. (canceled)

26. (canceled)

27. (canceled)

28. The method for configuring contention-based access parameters of an LAA device as claimed in claim 1, wherein the LBT priority class is determined by one of the following modes:
predefined LBT priority class is determined;
the LBT priority class is determined based on a service type;
the LBT priority class is configured by a base station to user equipment (UE).

29. The method for configuring contention-based access parameters of an LAA device as claimed in claim 1, wherein
a Quality of Service (QoS) Class Identifier (QCI) has a mapping/corresponding relationship with the LBT priority class; or,
different channels and/or different signals and/or different logical channels have a mapping/corresponding relationship with the LBT priority classes; or,
a data packet delay and/or a packet loss rate has a mapping/corresponding relationship with the LBT priority class; or,
GBR and/or Non-GBR resource types have a mapping/corresponding relationship with the LBT priority classes.

30. The method for configuring contention-based access parameters of an LAA device as claimed in claim 29, wherein the mapping/corresponding relationship between the different channels and/or different signals and/or different logical channels and the LBT priority classes is determined by one of the following modes:
a predefined mapping/corresponding relationship between the different channels and/or different signals and/or different logical channels and the LBT priority classes is determined;
the mapping/corresponding relationship between the different channels and/or different signals and/or different logical channels and the LBT priority classes is determined through upper-layer configuration;
the mapping/corresponding relationship between the different channels and/or different signals and/or different logical channels and the LBT priority classes is indicated by a base station.

31. (canceled)

32. (canceled)

33. (canceled)

34. An apparatus for configuring contention-based access parameters of a Licensed-Assisted Access (LAA) device, comprising:
a determination unit, configured to determine, according to different priority classes, different Listen Before Talk (LBT) mechanisms or different LBT mechanism parameter sets corresponding to the different priority classes;
an execution unit, configured to execute contention-based access to an unlicensed carrier by using the different LBT mechanisms or the different LBT mechanism parameter sets corresponding to the different priority classes; and
a transmission unit, configured to transmit, when a right of using the unlicensed carrier is successfully gained based on a used LBT mechanism or a used LBT mechanism parameter set, data by utilizing the unlicensed carrier.

35.-66. (canceled)

67. The method for configuring contention-based access parameters of an LAA device as claimed in claim 1, wherein a mapping/corresponding relationship between the different priority classes and the different LBT mechanisms or different LBT mechanism parameter sets is determined by one of the following modes:
a predefined mapping/corresponding relationship between the different priority classes and the different LBT mechanisms or different LBT mechanism parameter sets is acquired;
the mapping/corresponding relationship between the different priority classes and the different LBT mechanisms or different LBT mechanism parameter sets is indicated by a base station;
the mapping/corresponding relationship between the different priority classes and the different LBT mechanisms or different LBT mechanism parameter sets is determined through upper-layer signalling;
the mapping/corresponding relationship between the different priority classes and the different LBT mechanisms or different LBT mechanism parameter sets is indicated by a specific indication mode.

68. The method for configuring contention-based access parameters of an LAA device as claimed in claim 29, wherein that the QCI has a mapping/corresponding relationship with the LBT priority class comprises one of the followings:
an LBT priority class 1 corresponds to a QCI 1 or QCI 5 or QCI 66;
an LBT priority class 2 corresponds to a QCI 2 or QCI 3 or QCI 6.

69. The method for configuring contention-based access parameters of an LAA device as claimed in claim 1, wherein
values of n in a composition of a defer period corresponding to different priority classes are different; or,
for a selected LBT mechanism, a size of a contention window in the LBT mechanism parameter set is adjusted according to ACK/NACK fed back in each burst, or an interference measurement situation within a period of time, or different service types.

70. The method for configuring contention-based access parameters of an LAA device as claimed in claim 24, wherein contending for the right of using the unlicensed carrier by executing an LBT mechanism according to LBT parameters corresponding to different priority classes respectively comprises:
time-frequency resources are used based on different priority classes coexisting in the same burst or transmission period or subframe in a time division manner;
or,
multiple contention-based access processes are performed in parallel based on different priority classes; and/or, transmission is performed when a random backoff value N descends to 0, the random backoff value N is frozen when the random backoff value N has not descended to 0, and the random backoff value N decrement is continued when the channel is detected to be idle.

71. A channel access method, comprising:
performing, by a transmission device, channel access based on a priority class, and/or, a Listen Before Talk (LBT) mechanism or a LBT mechanism parameter set, before the transmission device performs data transmission.

72. The channel access method as claimed in claim 71, wherein the transmission device determines the priority class by one of the following modes:
the transmission device determines a predefined LBT priority class;
the transmission device determines the LBT priority class based on a service type;
the LBT priority class is configured by a base station to the transmission device.

73. The channel access method as claimed in claim 71, wherein LBT mechanisms used in the channel access comprise at least one of:
an LBT Cat2 mechanism or an enhanced LBT Cat2 mechanism;
an LBT Cat4 mechanism;
an LBT Cat3 mechanism;
or,
wherein parameters of LBT mechanism parameter sets used in the channel access comprise at least one of: a first CCA duration, a defer period, a maximum contention window CWmax, a minimum contention window CWmin, a random backoff value N, and n in a composition of a defer period.

74. The channel access method as claimed in claim 71, comprising at least one of the followings:
the priority class has a mapping/corresponding relationship with the LBT mechanism;
the priority class has a mapping/corresponding relationship with the LBT mechanism parameter set.

75. The channel access method as claimed in claim 71, comprising one of the followings:
a Quality of Service (QoS) Class Identifier (QCI) has a mapping/corresponding relationship with the LBT priority class; or,
different channels and/or different signals and/or different logical channels have a mapping/corresponding relationship with the LBT priority classes; or,
a data packet delay and/or a packet loss rate has a mapping/corresponding relationship with the LBT priority class; or,
GBR and/or Non-GBR resource types have a mapping/corresponding relationship with the LBT priority classes.

76. The channel access method as claimed in claim 75, wherein that the QCI has a mapping/corresponding relationship with the LBT priority class comprises one of the followings:
an LBT priority class 1 corresponds to a QCI 1 or QCI 5 or QCI 66;
an LBT priority class 2 corresponds to a QCI 2 or QCI 3 or QCI 6.

77. A transmission device, configured to perform channel access based on a priority class, and/or, a Listen Before Talk (LBT) mechanism or a LBT mechanism parameter set, before the transmission device performs data transmission.
